(19) United States
(12) Patent Application Publication
(10) Pub. No.: US 2019/0229790 A1
(43) Pub. Date: Jul. 25, 2019

(54) COMMUNICATION APPARATUS, COMMUNICATION TERMINAL, COMMUNICATION METHOD, AND RECORDING MEDIUM HAVING COMMUNICATION PROGRAM RECORDED THEREON

(71) Applicant: NEC Corporation, Minato-ku, Tokyo (JP)

(72) Inventor: Keishi KOSAKA, Tokyo (JP)

(73) Assignee: NEC Corporation, Minato-ku, Tokyo (JP)

(21) Appl. No.: 16/336,142

(22) PCT Filed: Sep. 20, 2017
(86) PCT No.: PCT/JP2017/033824

§ 371 Date: Mar. 25, 2019

(30) Foreign Application Priority Data
Sep. 29, 2016 (JP) 2016-191299

(51) Int. Cl. H04B 7/06; H04B 7/0456; H04B 7/0408; H01Q 21/06

(52) U.S. Cl. CPC H04B 7/0617; H04B 7/0456; H04B 7/0452; H01Q 21/06; H04B 7/0408

(57) ABSTRACT

A communication apparatus comprises a feeding unit, a plurality of communication units, and a MIMO processing unit. The plurality of communication units input to the feeding unit analog transmission signals obtained by converting digital transmission signals inputted by the MIMO processing unit into analog signals, convert analog received signals distributed and inputted by the feeding unit into digital signals based on the analog received signals, and input the digital signals to the MIMO processing unit. The feeding unit distributes the same number of analog signals based on the analog received signals as the number of the plurality of communication units to the plurality of communication units, and distributes the same number of analog transmission signals as the number of the plurality of communication units to a plurality of antenna elements in such a way that electromagnetic waves having a predetermined phase difference therebetween are radiated.

### TECHNICAL FIELD

The present invention relates to a communication apparatus, a communication terminal, a communication method, and a storage medium having a communication program stored thereon.

### BACKGROUND ART

For acceleration of communication, multiple input multiple output (MIMO) establishing communication between a base station and a user terminal by use of a plurality of antennas in the same bandwidth is widely used. In addition, beam forming using an array antenna including a plurality of antenna elements arranged at a certain interval is widely used. Then, for further acceleration of communication, use of multi-user MIMO (MU-MIMO) establishing communication between a base station and a plurality of user terminals by use of a plurality of antennas in the same bandwidth is under investigation. Note that, with regard to a communication apparatus such as a mobile base station, a method of providing MU-MIMO by separating signals transmitted to respective user terminals by performing MIMO and beam forming is under investigation.

PTL 1 discloses a wireless transmission system using a MIMO technology and the like, the wireless transmission system suppressing interference in the same cell in a downlink by applying a whitening filter on the transmission side.

FIG. 29 is a block diagram illustrating a configuration example of a MIMO communication apparatus 900 related to the present invention. As illustrated in FIG. 29, the MIMO communication apparatus 900 includes an array antenna 910 including n antenna elements 911-1 to 911-n, n communication circuits 930-1 to 930-n, a calibration network 940, a communication circuit for calibration 950, and a MIMO processing unit 960. Then, the MIMO communication apparatus 900 is a communication apparatus capable of communicating by MU-MIMO.

Furthermore, in the MIMO communication apparatus 900, the array antenna 910 and the MIMO processing unit 960 are connected to one another through the communication circuits 930-1 to 930-n by using n signal lines 970-1 to 970-n, respectively. In addition, the calibration network 940 is connected through n couplers 941-1 to 941-n to each of the signal lines 970-1 to 970-n which connect the array antenna 910 and the communication circuits 930-1 to 930-n. Then, the calibration network 940 is also connected to the communication circuit for calibration 950. The MIMO processing unit 960 is connected to the communication circuits 930-1 to 930-n and the communication circuit for calibration 950. Further, each of the communication circuits 930-1 to 930-n is connected to each of the n antenna elements 911-1 to 911-n included in the array antenna 910.

The MIMO processing unit 960 performs MIMO transmission-reception weighting processing, to be described later, of calculating a weight matrix. Further, the MIMO processing unit 960 performs calibration processing, to be described later, of calculating a correction factor. Each of the communication circuits 930-1 to 930-n inputs a signal into each of the antenna elements 911-1 to 911-n included in the array antenna 910. Each of the antenna elements 911-1 to 911-n converts the signal into an electromagnetic wave with directivity and radiates the electromagnetic wave. Then, the electromagnetic wave radiated from each of the antenna elements 911-1 to 911-n is received on the reception side. Specifically, for example, each of signals input from the communication circuits 930-1 to 930-n to the antenna elements 911-1 to 911-n is converted into an electromagnetic wave and radiated by each of the antenna elements 911-1 to 911-n. Then, each of the electromagnetic waves overlaps one another and become beams whose respective directions having maximizing strength for each signal aimed at each user terminal, and the beam is received on the reception side.

The MIMO processing unit 960 determines a weight matrix, based on reception information estimated by the MIMO communication apparatus 900 at reception of a signal. Then, the MIMO processing unit 960 multiplies each signal by the weight matrix, the each signal inputting to each of the antenna elements 911-1 to 911-n by each of the communication circuits 930-1 to 930-n. Further, the reception information refers to a matrix composed of amounts of amplitude and phase variations of a propagation path from the MIMO communication apparatus 900 to a user terminal.

Further, the MIMO processing unit 960 performs calibration processing of calculating a correction factor by which a signal is multiplied as described above. Specifically, for example, the MIMO processing unit 960 causes a communication circuit 930-i (where i is a natural number greater than or equal to 1 and less than or equal to n) to input a reference signal x into the communication circuit for calibration 950 through the calibration network 940. Further, the MIMO processing unit 960 causes the communication circuit for calibration 950 to input the reference signal x into the communication circuit 930-i (where i is a natural number greater than or equal to 1 and less than or equal to n) through the calibration network 940. In this case, signal reception processing and signal transmission processing are separately performed in both of the communication circuit 930-i and the communication circuit for calibration 950. Consequently, there is no reversibility between a transmission signal and a reception signal on a signal path between the communication circuit 930-i and the antenna element 911-i. Accordingly, the MIMO processing unit 960 calculates a correction factor allowing reversibility to be satisfied between the transmission signal and the reception signal on the signal path between the communication circuit 930-i and the antenna element 911-i, based on the reference signal x input to the communication circuit 930-i and the communication circuit for calibration 950, as described above. Then, the MIMO processing unit 960 multiplies each of the signals multiplied by a weight matrix as described above by the correction factor. Further, each of the communication circuits 930-1 to 930-n inputs each of the signals multiplied by the correction factor into the antenna elements 911-1 to 911-n.

In this case, an error may occur in the calibration processing performed by the MIMO processing unit 960. In that case, each signal input by the communication circuits 930-1 to 930-n is no longer a proper signal, and therefore a shape of a beam based on an electromagnetic wave radiated by each of the antenna elements 911-1 to 911-n degrades. Accordingly, each user terminal receives more of beams aimed at other user terminals, and therefore communication performance by MU-MIMO deteriorates.

Furthermore, when the MIMO processing unit 960 determines a weight matrix by zero forcing (ZF) processing in a case that the MIMO communication apparatus 900 transmits signals by beams to user terminals each of which is positioned in a different direction, a weight matrix is determined as follows. Specifically, a weight matrix is determined in such a way that a beam transmitted to one user terminal and a beam transmitted to another user terminal do not interfere with each other. More specifically, a weight matrix is determined in such a way that, for example, a null point (a point where a beam strength becomes 0) is formed in a direction of another user terminal in a line-of-sight environment with respect to each of a plurality of beams transmitted to a plurality of user terminals.

### CITATION LIST

### Patent Literature

PTL 1: Japanese Unexamined Patent Application Publication No. 2007-74318

### SUMMARY OF INVENTION

### Technical Problem

In the MIMO communication apparatus 900 in the example illustrated in FIG. 29, the communication circuits 930-1 to 930-n are connected to the antenna elements 911-1 to 911-n in the array antenna 910, respectively. Accordingly, each signal output from the communication circuits 930-1 to 930-n is converted into an electromagnetic wave and radiated. Thus, communication performance of the MIMO communication apparatus 900 is greatly affected by an error in the calibration processing. Then, null point formation with respect to beams based on electromagnetic waves radiated by mutually different antenna elements 911-1 to 911-n cannot be performed accurately.

Further, in a MIMO communication system using MU-MIMO or the like, each of beams simultaneously transmitted to and received from a plurality of user terminals is required to be properly separable in such a way as not to interfere with one another, in order to prevent degradation in communication performance.

However, PTL 1 does not particularly describe nor suggest mitigation of an effect by an error in the calibration processing in order to prevent each of beams transmitted to and received from a plurality of user terminals from interfering with one another. Further, the MIMO communication apparatus 900 in the example illustrated in FIG. 29 does not particularly assume mitigation of an effect by an error in the calibration processing in order to prevent each of beams transmitted to and received from a plurality of user terminals from interfering with one another. Therefore, communication performance may degrade when, for example, an error occurs in the calibration processing in the wireless transmission system described in PTL 1 and the MIMO communication apparatus 900 in the example illustrated in FIG. 29.

Accordingly, an object of the present invention is to provide a communication apparatus, a communication terminal, and a control method of a communication apparatus that are capable of preventing degradation in communication performance.

### Solution to Problem

In order to achieve the object described above, a communication apparatus, according to one aspect of the present invention, includes: a plurality of communication means for converting a digital signal into an analog signal, and vice versa; feeding means for distributing input analog transmission signals to a plurality of antenna elements, and distributing, to the plurality of communication means, analog reception signals received and input by the plurality of antenna elements; and MIMO processing means for, based on a MIMO communication technique, inputting digital signals for transmission to the plurality of communication means, and performing processing on digital signals input by the plurality of communication means, the digital signals being based on the analog reception signals, wherein the plurality of communication means input, into the feeding means, the analog transmission signals acquired by converting the digital signals for transmission input by the MIMO processing means into the analog signals, and convert the analog reception signals distributed and input by the feeding means into the digital signals based on the analog reception signals and input the digital signals into the MIMO processing means, and the feeding means distributes the analog signals based on a same number of the analog reception signals as the plurality of communication means, to the plurality of communication means, and distributes a same number of the analog transmission signals as the plurality of communication means, to the plurality of antenna elements, in such a way that electromagnetic waves having respective predetermined phase differences are radiated.

In order to achieve the object described above, a communication terminal, according to one aspect of the present invention, includes: a plurality of communication means for converting a digital signal into an analog signal, and vice versa; feeding means for distributing input analog transmission signals to a plurality of antenna elements, and distributing, to the plurality of communication means, analog reception signals received and input by the plurality of antenna elements; and MIMO processing means for, based on a MIMO communication technique, inputting digital signals for transmission to the plurality of communication means and performing processing on digital signals input by the plurality of communication means, the digital signals being based on the analog reception signals, wherein the plurality of communication means input, into the feeding means, the analog transmission signals acquired by converting the digital signals for transmission input by the MIMO processing means into the analog signals, and convert the analog reception signals distributed and input by the feeding means into the digital signals based on the analog reception signals, and input the digital signals into the MIMO processing means, and the feeding means distributes the analog signals based on a same number of the analog reception signals as the plurality of communication means, to the plurality of communication means, and distributes a same number of the analog transmission signals as the plurality of communication means, to the plurality of antenna elements, in such a way that electromagnetic waves having respective predetermined phase differences are radiated.

In order to achieve the object described above, a control method for a communication apparatus, according to one aspect of the present invention, includes: a communication step of converting a digital signal into an analog signal, and vice versa; a feeding step of distributing input analog transmission signals to a plurality of antenna elements, and distributing, to the plurality of communication means, analog reception signals received and input by the plurality of antenna elements; a MIMO processing step of, based on a MIMO communication technique, inputting digital signals for transmission to the plurality of communication means, and performing processing on digital signals input by the plurality of communication means, the digital signals being based on the analog reception signals; the communication step further comprising: inputting, into the feeding means executing the feeding step, the analog transmission signals acquired by converting the digital signals for transmission input to the plurality of communication means in the MIMO processing step into the analog signals; and converting the analog signals based on the analog reception signals distributed and input by the feeding means into the digital signals based on the analog reception signals, and inputting the digital signals into the MIMO processing means executing the MIMO processing step; the feeding step further comprising: distributing the analog signals based on a same number of the analog reception signals as the plurality of communication means, to the plurality of communication means; and distributing a same number of the analog transmission signals as the plurality of communication means, to the plurality of antenna elements, in such a way that electromagnetic waves having respective predetermined phase differences are radiated.

### Advantageous Effects of Invention

The present invention is able to prevent degradation in communication performance.

### BRIEF DESCRIPTION OF DRAWINGS

FIG. 1 is a block diagram illustrating a configuration example of a MIMO communication apparatus according to a first example embodiment.

FIG. 2 is a front view illustrating a configuration example of an array antenna according to the first example embodiment.

FIG. 3 is a front view illustrating a first other configuration example of the array antenna according to the first example embodiment.

FIG. 4 is a front view illustrating a second other configuration example of the array antenna according to the first example embodiment.

FIG. 5 is a configuration diagram illustrating a third other configuration example of the array antenna according to the first example embodiment.

FIG. 6 is a configuration diagram illustrating a connection example between the array antenna, a feeding network, and a communication circuit according to the first example embodiment.

FIG. 7 is an example of a diagram illustrating an example of a signal strength in each direction of a fixed beam according to the first example embodiment.

FIG. 8 is a flowchart illustrating an operation example of the MIMO communication apparatus according to the first example embodiment.

FIG. 9 is a block diagram illustrating a first other configuration example of the MIMO communication apparatus according to the first example embodiment.

FIG. 10 is a block diagram illustrating a second other configuration example of the MIMO communication apparatus according to the first example embodiment.

FIG. 11 is a block diagram illustrating a third other configuration example of the MIMO communication apparatus according to the first example embodiment.

FIG. 12 is a block diagram illustrating a fourth other configuration example of the MIMO communication apparatus according to the first example embodiment.

FIG. 13 is a block diagram illustrating a configuration example of a MIMO communication apparatus according to a second example embodiment.

FIG. 14 is a diagram illustrating an example of a signal strength in each direction of a fixed beam according to the second example embodiment.

FIG. 15 is a diagram illustrating another example of a signal strength in each direction of a fixed beam according to the second example embodiment.

FIG. 16 is a block diagram illustrating a configuration example of a MIMO communication apparatus according to a third example embodiment.

FIG. 17 is a front view illustrating a configuration example of an array antenna according to the third example embodiment.

FIG. 18 is a front view illustrating a first other configuration example of the array antenna according to the third example embodiment.

FIG. 19 is a front view illustrating a second other configuration example of the array antenna according to the third example embodiment.

FIG. 20 is a block diagram illustrating a configuration example of a MIMO communication apparatus according to a fourth example embodiment.

FIG. 21 is a front view illustrating a configuration example of an array antenna according to the fourth example embodiment.

FIG. 22 is a front view illustrating a first other configuration example of the array antenna according to the fourth example embodiment.

FIG. 23 is a front view illustrating a second other configuration example of the array antenna according to the fourth example embodiment.

FIG. 24 is a front view illustrating a third other configuration example of the array antenna according to the fourth example embodiment.

FIG. 25 is a block diagram illustrating a configuration example of a MIMO communication apparatus according to a fifth example embodiment.

FIG. 26 is a block diagram illustrating a configuration example of a MIMO communication apparatus according to a sixth example embodiment.

FIG. 27 is a flowchart illustrating an operation example of the MIMO communication apparatus according to the sixth example embodiment.

FIG. 28 is a flowchart illustrating another operation example of the MIMO communication apparatus according to the sixth example embodiment.

FIG. 29 is a block diagram illustrating a configuration example of a related MIMO communication apparatus.

### EXAMPLE EMBODIMENT

### First Example Embodiment

A first example embodiment will be described with reference to drawings.

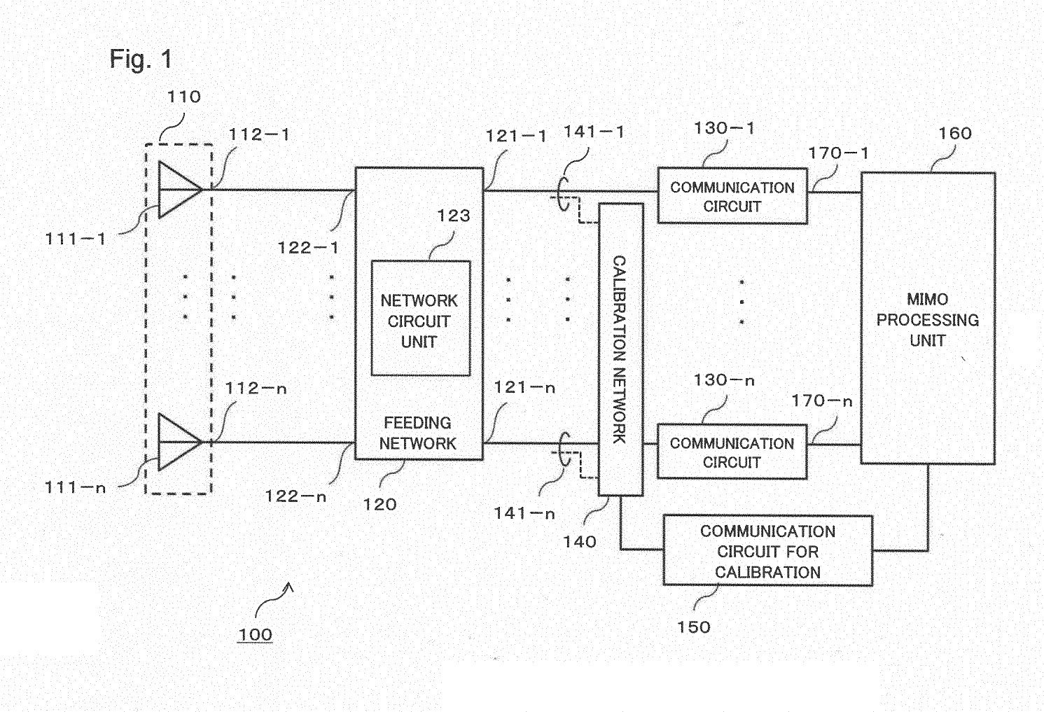

FIG. 1 is a block diagram illustrating a configuration example of a MIMO communication apparatus 100 according to the present example embodiment. In the example illustrated in FIG. 1, the MIMO communication apparatus 100 includes a feeding network 120, n communication circuits 130-1 to 130-n, a calibration network 140, a communication circuit for calibration 150, and a MIMO processing unit 160. Then, the feeding network 120 is connected to an array antenna 110. Note that the array antenna 110 may be installed inside the MIMO communication apparatus 100 or may be installed outside the MIMO communication apparatus 100.

The MIMO communication apparatus 100 here refers to a communication apparatus capable of communicating by MU-MIMO. Note that in the MIMO communication apparatus 100, n signal lines 170-1 to 170-n connects the array antenna 110 with the feeding network 120, the feeding network 120 with the communication circuits 130-1 to 130-n, and the communication circuits 130-1 to 130-n with the MIMO processing unit 160.

In addition, the calibration network 140 is connected through n couplers 141-1 to 141-n to each of the signal lines 170-1 to 170-n which connect the feeding network 120 and the communication circuits 130-1 to 130-n.

The array antenna 110 includes n antenna elements 111-1 to 111-n. Additionally, the array antenna 110 may be provided with n antenna ports 112-1 to 112-n as input-output terminals. In the following description, a case that the array antenna 110 is provided with the antenna ports 112-1 to 112-n will be described as an example. In such a configuration, the antenna elements 111-1 to 111-n are connected to the antenna ports 112-1 to 112-n, respectively.

The feeding network 120 includes a network circuit unit 123. Additionally, the feeding network 120 may be provided with n input-output ports 121-1 to 121-n on the communication circuits 130-1 to 130-n side and n input-output ports 122-1 to 122-n on the array antenna 110 side as input-output terminals. In the following description, a case that the feeding network 120 is provided with the input-output ports 121-1 to 121-n and the input-output ports 122-1 to 122-n will be described as an example. In such a configuration, the input-output ports 121-1 to 121-n and the communication circuits 130-1 to 130-n are connected through the signal lines 170-1 to 170-n, respectively. Further, the input-output ports 122-1 to 122-n and the antenna ports 112-1 to 112-n in the array antenna 110 are connected through the signal lines 170-1 to 170-n, respectively. Then, such connection allows transmission and reception of various signals between the array antenna 110 and the feeding network 120, and between the feeding network 120 and the communication circuits 130-1 to 130-n.

In the following description, when each of the n antenna elements 111-1 to 111-n included in the array antenna 110 does not need to be distinctively described, the antenna elements 111-1 to 111-n may be generically referred to as antenna elements 111. Further, in the following description, when each of the n antenna ports 112-1 to 112-n provided on the array antenna 110 does not need to be distinctively described, the antenna ports 112-1 to 112-n may be generically referred to as antenna ports 112. Further, in the following description, when each of the n input-output ports 121-1 to 121-n provided in the feeding network 120 does not need to be distinctively described, the input-output ports 121-1 to 121-n may be generically referred to as input-output ports 121. Further, in the following description, when each of the n input-output ports 122-1 to 122-n provided in the feeding network 120 does not need to be distinctively described, the input-output ports 122-1 to 122-n may be generically referred to as input-output ports 122. Further, in the following description, when each of the n communication circuits 130-1 to 130-n does not need to be distinctively described, the communication circuits 130-1 to 130-n may be generically referred to as communication circuits 130. Further, in the following description, when each of the n couplers 141-1 to 141-n does not need to be distinctively described, the couplers 141-1 to 141-n may be generically referred to as couplers 141. Further, in the following description, when each of the n signal lines 170-1 to 170-n does not need to be distinctively described, the signal lines 170-1 to 170-n may be generically referred to as signal lines 170.

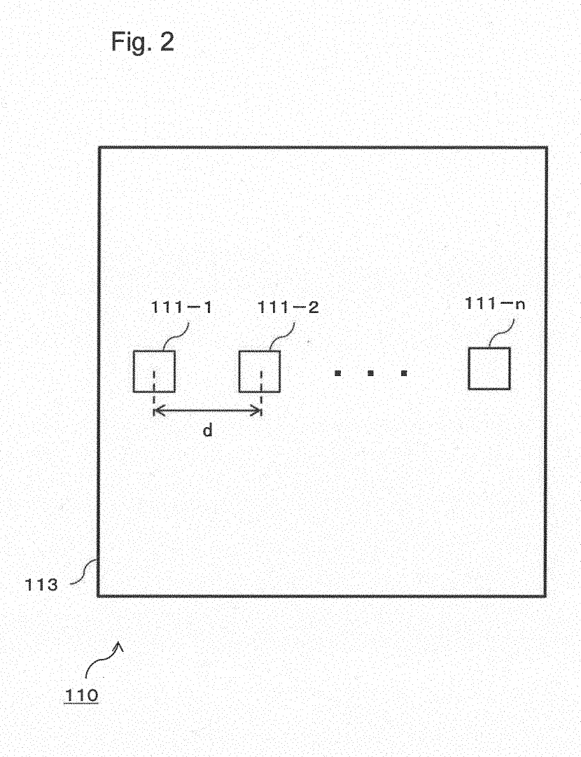

FIG. 2 is a front view illustrating a configuration example of the array antenna 110. In the example illustrated in FIG. 2, the array antenna 110 includes the antenna elements 111-1 to 111-n and a conductive reflector 113. In this case, each of the antenna elements 111-1 to 111-n is installed on the conductive reflector 113 in such a way that a distance d between antenna elements 111 adjoining one another (for example, between the antenna element 111-1 and the antenna element 111-2) is ½ of a wavelength λ of a beam transmitted and received by the array antenna 110. With such a configuration, the distance d between antenna elements 111 adjoining one another is not so close that electromagnetic coupling is generated in the antenna elements 111-1 to 111-n, and therefore degradation in antenna performance caused by electromagnetic coupling can be prevented when beam forming is performed by use of the array antenna 110. Further, the distance d between antenna elements 111 adjoining one another is not so distant that an effect of a grating lobe occurs, and therefore an effect of a grating lobe can be suppressed when beam forming is performed by use of the array antenna 110. Note that a type of the antenna elements 111-1 to 111-n is not limited as long as the antenna element is capable of transmitting and receiving an electromagnetic wave, such as a dipole antenna, a patch antenna, or a monopole antenna.

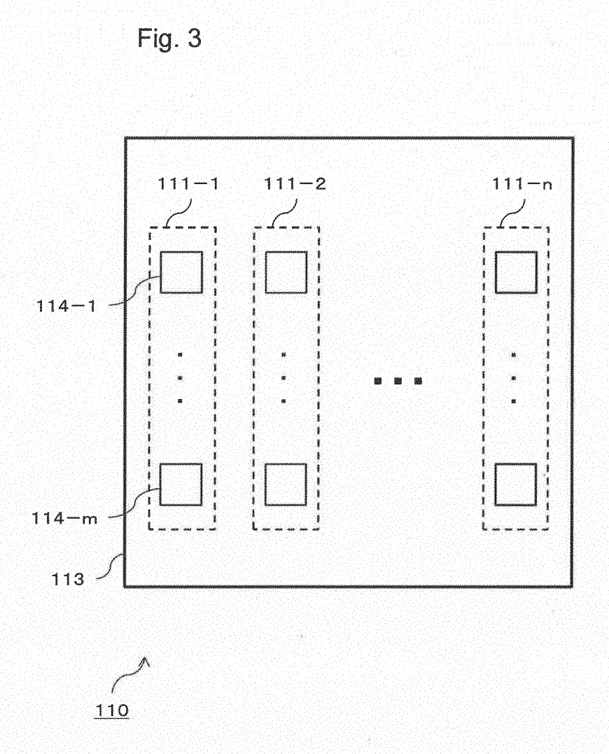

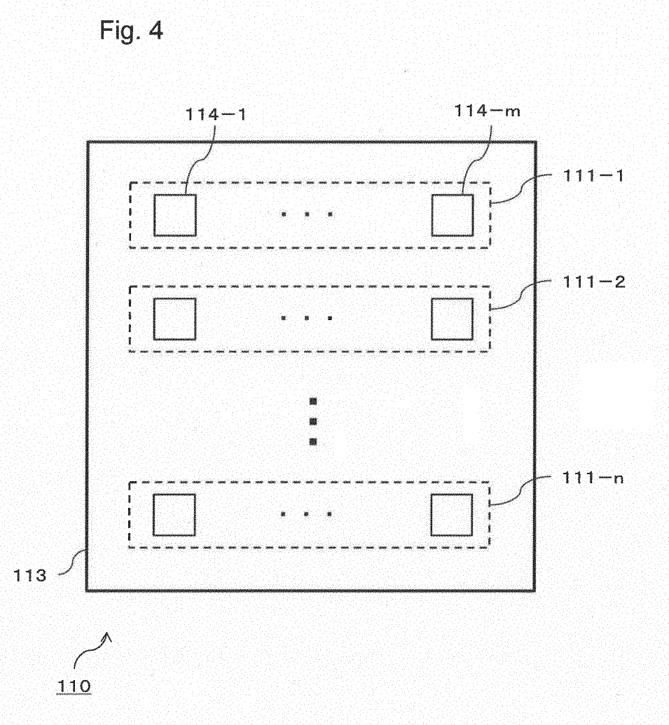

FIG. 3 is a front view illustrating a first other configuration example of the array antenna 110. As is the case with the example illustrated in FIG. 3, each of the antenna elements 111-1 to 111-n may include any number of sub-antenna elements 114-1 to 114-m (where the value of m may be m=n or m n). As will be described later, in the example illustrated in FIG. 3, a method of distributing signals output by the communication circuits 130 among the respective sub-antenna elements 114-1 to 114-m is not particularly limited and may be a distribution with same-phase and same-power. FIG. 4 is a front view illustrating a second other configuration example of the array antenna 110. In this case, the antenna elements 111-1 to 111-n may be formed in such a way that the sub-antenna elements 114-1 to 114-m are arranged side by side in a vertical direction with respect to a horizontal plane in a vertically oriented manner as illustrated in FIG. 3, or may be formed in such a way that the sub-antenna elements 114-1 to 114-m are arranged side by side in a horizontal direction in a horizontally oriented manner as illustrated in FIG. 4.

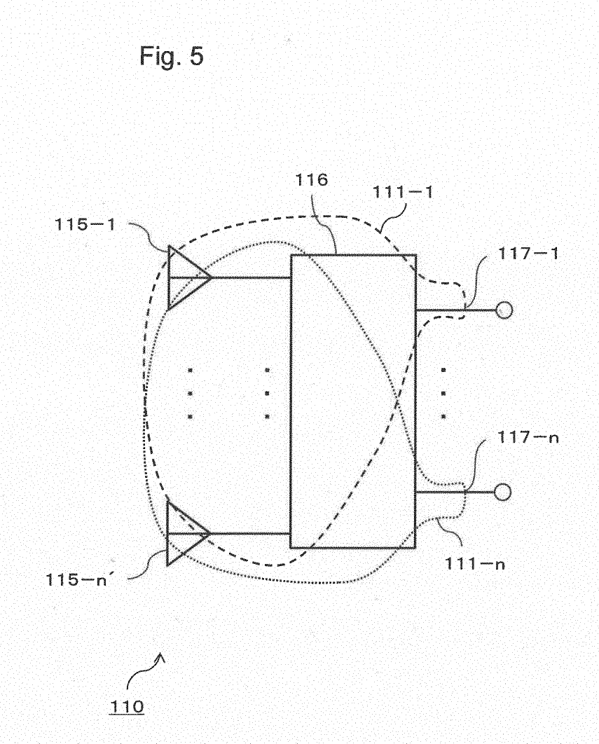

FIG. 5 is a configuration diagram illustrating a third other configuration example of the array antenna 110. As is the case with the example illustrated in FIG. 5, the array antenna 110 may include n′ antenna elements 115-1 to 115-n′ and a sub-feeding network 116. Then, the sub-feeding network 116 may be provided with n antenna ports 117-1 to 117-n to which a signal is input from each of the communication circuits 130-1 to 130-n through the feeding network 120. In this case, the antenna elements 115-1 to 115-n′ and the sub-feeding network 116 are connected to one another. When a signal is input to each of the antenna ports 117-1 to 117-n, the sub-feeding network 116 superposes the respective signals on one another and distributes the superposed signal to each of the antenna elements 115-1 to 115-n′. Note that, in the example illustrated in FIG. 5, the antenna ports 117-1 to 117-n provided in the sub-feeding network 116 correspond to the antenna ports on the antenna elements 115-1 to 115-n′. In addition, in the example illustrated in FIG. 5, each of the antenna elements 111-1 to 111-n is configured to share the antenna elements 115-1 to 115-n′ as sub-antenna elements. Then the value of n′ may be n′=n or n′≠n.

Each of the communication circuits 130-1 to 130-n converts an input analog signal into a digital signal and converts an input digital signal into an analog signal. For example, each of the communication circuits 130-1 to 130-n converts a digital signal input from the MIMO processing unit 160 into an analog signal and inputs the analog signal into the communication circuit for calibration 150 through the calibration network 140. Further, for example, each of the communication circuits 130-1 to 130-n converts an analog signal input from the feeding network 120 into a digital signal and inputs the digital signal into the MIMO processing unit 160.

Note that, for example, each of the communication circuits 130-1 to 130-n includes a radio frequency (RF) front end, an analog to digital (A-D) converter, and the like. For example, the RF front end is an electric circuit including a filter such as a surface acoustic wave (SAW) filter, a switch such as a radio frequency (RF) switch, an amplifier circuit amplifying a signal transmitted and received by the MIMO communication apparatus 100, and the like.

The calibration network 140 is connected through the n couplers 141-1 to 141-n to each of the signal lines 170-1 to 170-n which connect the feeding network 120 and the communication circuits 130. Further, the calibration network 140 is also connected to the communication circuit for calibration 150. With such a configuration, for example, the calibration network 140 relays transmission and reception of various signals between the communication circuits 130-1 to 130-n and the communication circuit for calibration 150, as will be described later.

The communication circuit for calibration 150 converts an input analog signal into a digital signal and converts an input digital signal into an analog signal. For example, the communication circuit for calibration 150 converts an analog signal input from the communication circuits 130-1 to 130-n through the calibration network 140 into a digital signal and inputs the digital signal into the MIMO processing unit 160. Further, for example, the communication circuit for calibration 150 converts a digital signal input from the MIMO processing unit 160 into an analog signal and inputs the analog signal into the communication circuits 130-1 to 130-n through the calibration network 140.

The MIMO processing unit 160 is connected to each of the n communication circuits 130-1 to 130-n. Further, the MIMO processing unit 160 is connected to the communication circuit for calibration 150. With such a configuration, the MIMO processing unit 160 can transmit and receive a digital signal to and from each of the n communication circuits 130-1 to 130-n and the communication circuit for calibration 150. Then, the MIMO processing unit 160 transmits and receives the digital signal and performs MIMO transmission-reception weighting processing and calibration processing. Further, the MIMO processing unit 160 includes a field programmable gate array (FPGA) and the like.

The MIMO transmission-reception weighting processing here refers to processing of calculating a weight matrix by the MIMO processing unit 160. A weight matrix here refers to a matrix by which a signal input to each of the antenna elements 111-1 to 111-n by the communication circuits 130-1 to 130-n at transmission are multiplied and a matrix by which a signal distributed to each of the communication circuits 130-1 to 130-n by the feeding network 120 at reception are multiplied. Specifically, for example, at reception, when the array antenna 110 receives a plurality of communication electromagnetic waves and signals based on the plurality of communication electromagnetic waves are distributed to the respective communication circuits 130-1 to 130-n by the feeding network 120, each of the distributed signals is multiplied by the weight matrix.

An example of the MIMO transmission-reception weighting processing will be described in more detail. The MIMO transmission-reception weighting processing will be hereinafter described in a case that the MIMO communication apparatus 100 radiates a beam on which a plurality of electromagnetic waves are superposed. Note that a character in [ ] denotes a vector. In addition, for the sake of simplicity, it is assumed that a number of user terminals communicating with the MIMO communication apparatus 100 and a number of the communication circuits 130 are equal to one another. In other words, it is assumed that the number of user terminals communicating with the MIMO communication apparatus 100 and the number of the communication circuits 130-1 to 130-n are both n. Note that t stands for transmit in the following description. Note that r stands for receive.

In the MIMO communication apparatus 100, the array antenna 110 receives a predetermined reference signal xᵢ transmitted from each of the n user terminals. In this case, when signals distributed and input into each of the communication circuits 130-1 to 130-n, based on the reference signal xᵢ transmitted by a user terminal i, are collectively denoted as [yᵢ], [yᵢ] is expressed as [yᵢ]=xᵢ×[hᵢ]. Accordingly, since xᵢ is known, a matrix Hᵤ being a channel matrix related to each of all channels in an upstream direction (a direction from the user terminals 1 to n toward the MIMO communication apparatus 100) can be determined by Hᵤ={[h₁], [h₂], . . . , [hₙ]}.

Note that when all the reference signals x₁ to xₙ transmitted by the user terminals 1 to n are collectively denoted as a vector [x], [y] being a collective vector notation of all signals y₁ to yₙ distributed and input into the communication circuits 130-1 to 130-n is expressed by [y]=Hᵤ[x]. Assuming that a channel has reversibility here, a matrix H_{d} being a channel matrix related to each of all channels in a downstream direction (a direction from the MIMO communication apparatus 100 toward the user terminals 1 to n) is expressed by H_{d}=Hᵤ^{T} (a matrix attached with T denotes a transposed matrix; Hᵤ denotes a channel matrix in the upstream direction; and H_{d} denotes a channel matrix in the downstream direction). Additionally, when all signals output from the respective communication circuits 130-1 to 130-n are collectively denoted as a vector [yₜ], [xᵣ] collecting signals received by the respective user terminals 1 to n is expressed by [xᵣ]=H_{d}×[yₜ].

When all information transmitted to the respective user terminals 1 to n is collectively denoted as a vector [S] here, a signal in which elements of the vector [S] are combined (for example, a signal transmitted to each user is multiplied by a coefficient and then added together) is output from each of the communication circuits 130-1 to 130-n. In this case, a matrix indicating a method of combining elements of [S] is a weight matrix W. Beam forming refers to making every signal [yₜ] output from each of the communication circuits 130-1 to 130-n expressed as [yₜ]=W[S]. Then, a vector [wᵢ] in each column of W denotes a distribution and a weight of a signal sᵢ (one of the elements of [S]) with respect to each communication circuit.

For example, when determining a weight matrix by ZF processing, the MIMO processing unit 160 here calculates W by performing the following calculation. Specifically, when the number of the communication circuits 130 is greater than the number of the user terminals, the MIMO processing unit 160 calculates W=H_{d}^{H}(H_{d}H_{d}^{H})⁻¹, based on the concept of the Moore-Penrose inverse. Further, when the number of the communication circuits 130 is equal to the number of the user terminals, the MIMO processing unit 160 calculates W=H_{d}⁻¹. In this case, H_{d}^{H} denotes the adjoint matrix of H_{d}. Further, H_{d}⁻¹ denotes the inverse matrix of H_{d}.

A signal [xᵣ] collecting signals received at the respective user terminals 1 to n is expressed as [xᵣ]=H_{d}×[yₜ]=H_{d}×W×[S]=H_{d}H_{d}⁻¹×[S]=[S]. Accordingly, it is understood that information transmitted to each of the user terminals 1 to n is separable by the user terminals 1 to n.

Note that while there is an algorithm for calculating a weight matrix other than the ZF processing, the ZF processing has a characteristic that processing is simple and easy.

The calibration processing refers to processing of calculating a correction factor. In this case, the MIMO processing unit 160 multiplies each of signals by a correction factor, the each of signals being multiplied by a weight matrix.

An example of the calibration processing will be described in more detail. For example, in the calibration processing, the MIMO processing unit 160 causes a communication circuit 130-i (where i is a natural number greater than or equal to 1 and less than or equal to n) to input a reference signal x into the communication circuit for calibration 150 through the calibration network 140.

Then, the signal y_{(i-c)} input to the communication circuit for calibration 150 is expressed as follows.

y_{(i-c)}=dt(i)×hdc(i)×cr×x Equation 1

In this case, (i-c) in y_{(i-c)} indicates a signal input to the communication circuit for calibration 150 from the communication circuit 130-i. Further, dt(i) is a coefficient indicating a signal change generated in the reference signal x when the reference signal x is output from the communication circuit 130-i. Further, hdc(i) is a coefficient indicating a signal change generated in a signal path between the communication circuit 130-i and the communication circuit for calibration 150. Further, cr is a coefficient indicating a signal change when a signal input to the communication circuit for calibration 150 is received by the communication circuit for calibration 150.

Further, for example, in the calibration processing, the MIMO processing unit 160 causes the communication circuit for calibration 150 to input a reference signal x into a communication circuit 130-i (where i is a natural number greater than or equal to 1 and less than or equal to n) through the calibration network 140.

Then, the signal y_{(c-i)} input to the communication circuit 130-i is expressed as follows.

y_{(c-i)}=ct×hcd(i)×dr(i)×x Equation 2

In this case, (c-i) in y_{(c-i)} indicates a signal input to the communication circuit 130-i from the communication circuit for calibration 150. Further, ct is a coefficient indicating a signal change generated in the reference signal x when the reference signal x is output from the communication circuit for calibration 150. Further, hcd(i) is a coefficient indicating a signal change generated in a signal path between the communication circuit for calibration 150 and the communication circuit 130-i. Further, dr(i) is a coefficient indicating a signal change generated when a signal input to the communication circuit 130-i is received by the communication circuit 130-i.

Then, based on aforementioned Equations 1 and 2, the MIMO processing unit 160 calculates a correction factor.

In this case, since there is reversibility between a transmission signal and a reception signal on the signal path between the communication circuit 130-i and the communication circuit for calibration 150, a relational expression is hdc(i)=hcd(i). However, in the communication circuit 130-i and the communication circuit for calibration 150, signal reception processing and signal transmission processing are separately performed, and therefore there is no reversibility between a transmission signal and a reception signal. Accordingly, with regard to dt(i) and dr(i), a relational expression dt(i)≠dr(i) is satisfied. Further, with regard to ct and cr, a relational expression ct≠cr is satisfied.

Note that the relational expression dt(i)≠dr(i) is also satisfied when a signal is transmitted to and received from a communication counterpart by use of the array antenna 110. Specifically, when transmitting signals to a plurality of user terminals, the MIMO communication apparatus 100 estimates each coefficient for signal variation in a channel in the upstream direction, based on reference signals transmitted in advance from a plurality of destination user terminals. Further, the MIMO communication apparatus 100 determines each coefficient for signal variation in a channel in the downstream direction from that in the upstream direction on the assumption that there is reversibility between the channel in the upstream direction and the channel in the downstream direction. Then, based on the determined coefficient for signal variation in the channel in the downstream direction, the MIMO communication apparatus 100 performs the MIMO transmission-reception weighting processing described above. However, dt(i)≠dr(i) is satisfied as described above, and therefore there is no reversibility for a signal transmitted and received between the MIMO communication apparatus 100 and a user terminal. Accordingly, the MIMO communication apparatus 100 corrects signals input to the communication circuits 130-1 to 130-n by performing the calibration processing.

The calibration processing is performed by use of y_{(i-c)} and y_{(c-i)} described above. Specifically, the calibration processing is performed by use of z(i)=y_{(c-i)}/y_{(i-c)} being a ratio of y_{(i-c)} to y_{(c-i)}, that is, z(i)=(ct×dr(i))/(dt(i)×cr).

First, one of the communication circuits 130 to be referred to is determined from the communication circuits 130-1 to 130-n. It is assumed in the following description that one of the communication circuits 130 to be referred to is the communication circuit 130-1. Next, a correction factor cal(i)=z(i)/z(1), that is, cal(i)=(dr(i)×dt(1))/(dt(i)×dr(1)) is calculated. Then, a signal yₜ(i) performed by the MIMO transmission-reception weighting processing is multiplied by the correction factor cal(i), and thus a signal y′(i) output from each communication circuits 130 becomes y′(i)=cal(i)×yₜ(i). As described above, the calibration processing is performed in such a way that each signal ratio between transmission and reception at respective communication circuits 130 matches a signal ratio between transmission and reception at one of the communication circuits 130 to be referred to, and a relative deviation between the communication circuits 130 is eliminated. Further, a signal multiplied by a weight matrix and a correction factor may be referred to as a signal after calibration-processing in the following description.

A signal after weighting processing and calibration-processing is input into the network circuit unit 123 from each of the communication circuits 130-1 to 130-n through each of the input-output ports 121-1 to 121-n provided in the feeding network 120. Further, in the network circuit unit 123, each input signal is distributed, which corresponds to performing discrete Fourier transform or inverse transform processing not including digital processing. Then, the network circuit unit 123 transmits the signals distributed as described above to the respective antenna elements 111-1 to 111-n included in the array antenna 110 through the respective input-output ports 122-1 to 122-n provided in the feeding network 120. Specifically, for example, the network circuit unit 123 distributes a signal input through the first input-output port 121-1 to each of the antenna elements 111-1 to 111-n in such a way that the signal has a certain fixed phase relation with a similar output level. Further, for example, the network circuit unit 123 distributes a signal input through the first input-output port 121-2 to each of the antenna elements 111-1 to 111-n in such a way that the signal has another certain fixed phase relation with a similar output level. Note that the network circuit unit 123 similarly distributes signals input through the first input-output ports 121-3 to 121-n to each of the antenna elements 111-1 to 111-n. In this case, a phase difference δa is different from a phase difference δb, the phase difference δa being between signals at respective adjoining input-output ports 122-1 to 122-n when a signal input through an input-output port 121-a is output to the respective input-output ports 122-1 to 122-n, and the phase difference δb being between signals at respective adjoining input-output ports 122-1 to 122-n when a signal input through an input-output port 121-b is output to the respective input-output ports 122-1 to 122-n. Note that a and b are any natural numbers less than or equal to n that are different from one another. Note that, for example, the network circuit unit 123 is an electric circuit network providing a Butler matrix, a Blass matrix, or a Rotman lens.

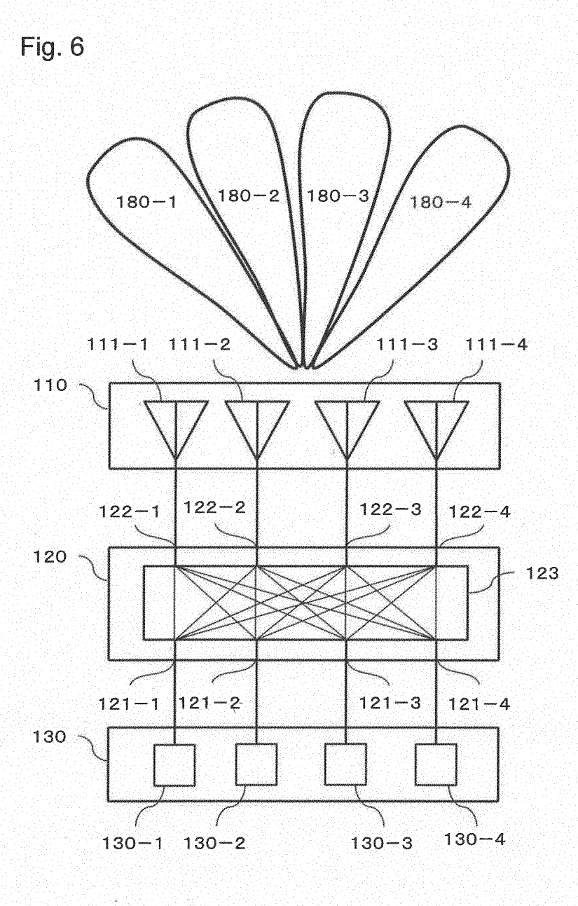

FIG. 6 is a configuration diagram illustrating a connection example between the array antenna 110, the feeding network 120, and the communication circuits 130. In the example illustrated in FIG. 6, the array antenna 110 including four antenna elements 111-1 to 111-4 and the feeding network 120 connected to four communication circuits 130-1 to 130-4 are connected to one another.

In the example illustrated in FIG. 6, the network circuit unit 123 distributes, to the respective antenna elements 111-1 to 111-4, signals after weighting processing and calibration-processing input through the four input-output ports 121-1 to 121-4 provided in the feeding network 120. Specifically, for example, when a signal after weighting processing and calibration-processing is input from the communication circuit 130-1 through the input-output port 121-1, the network circuit unit 123 distributes the signal to each of the antenna elements 111-1 to 111-4 through the input-output ports 122-1 to 122-4. Further, for example, when a signal after weighting processing and calibration-processing is input from the communication circuit 130-2 through the input-output port 121-2, the network circuit unit 123 distributes the signal to each of the antenna elements 111-1 to 111-4 through the input-output ports 122-1 to 122-4. Then, for example, when a signal after weighting processing and calibration-processing is input from the communication circuit 130-3 through the input-output port 121-3, the network circuit unit 123 distributes the signal to each of the antenna elements 111-1 to 111-4 through the input-output ports 122-1 to 122-4. For example, when a signal after weighting processing and calibration-processing is input from the communication circuit 130-4 through the input-output port 121-4, the network circuit unit 123 distributes the signal to each of the antenna elements 111-1 to 111-4 through the input-output ports 122-1 to 122-4.

Each signal distributed by the network circuit unit 123 is radiated from the antenna elements 111-1 to 111-4 as a plurality of electromagnetic waves. Then, the plurality of electromagnetic waves overlaps one another and forms a beam. Further, a plurality of beams may be formed by signal distribution by the network circuit unit 123. In this case, since a signal phase difference between antenna elements based on distribution by the network circuit unit 123 varies at the respective input-output ports 121-1 to 121-4, the respective beams are strongly radiated to areas in different predetermined directions. Additionally, since the distribution at the network circuit unit 123 described above is performed at a constant ratio, a direction in which each of the beams is strongly radiated is constant. A beam formed by overlapping electromagnetic waves one another is referred to as a fixed beam here, the electromagnetic waves being radiated from the antenna elements 111-1 to 111-4 by signal distribution by the network circuit unit 123. In the example illustrated in FIG. 6, beams are strongly radiated in directions indicated by fixed beams 180-1 to 180-4.

The fixed beam 180-1 is a beam formed by mixing electromagnetic waves radiated from the antenna elements 111-1 to 111-4, based on respective signals being output from the communication circuit 130-1 and being distributed to the antenna elements 111-1 to 111-4 by the network circuit unit 123. Further, the fixed beam 180-2 is a beam formed by mixing electromagnetic waves radiated from the antenna elements 111-1 to 111-4, based on respective signals being output from the communication circuit 130-2 and being distributed to the antenna elements 111-1 to 111-4 by the network circuit unit 123. The fixed beam 180-3 is a beam formed by mixing electromagnetic waves radiated from the antenna elements 111-1 to 111-4, based on respective signals being output from the communication circuit 130-3 and being distributed to the antenna elements 111-1 to 111-4 by the network circuit unit 123. The fixed beam 180-4 is a beam formed by mixing electromagnetic waves radiated from the antenna elements 111-1 to 111-4, based on respective signals being output from the communication circuit 130-4 and being distributed to the antenna elements 111-1 to 111-4 by the network circuit unit 123. Then, the fixed beams 180-1 to 180-4 further overlap one another by the weighting processing in the MIMO processing unit 160 and form an electromagnetic wave (hereinafter described as a “composite beam”) having directivity related to one signal; and the composite beam is received by a user terminal.

Furthermore, a signal strength in a direction in which each of the fixed beams 180-1 to 180-4 is strongly radiated becomes strongest when the antenna elements 111-1 to 111-4 are installed at regular intervals in the array antenna 110. The reason is that electromagnetic waves radiated from the antenna elements 111-1 to 111-4 overlap one another in the same phase in the directions in which the respective fixed beams 180-1 to 180-4 are strongly radiated.

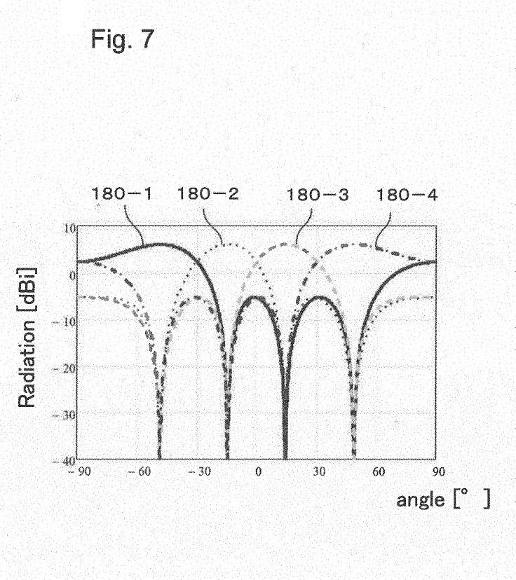

FIG. 7 is a diagram illustrating an example of a signal strength in each direction of the fixed beams 180-1 to 180-4. FIG. 7 indicates a signal strength of the fixed beam 180-1 in a solid line, indicates a signal strength of the fixed beam 180-2 in a dotted line, indicates a signal strength of the fixed beam 180-3 in a broken line, and indicates a signal strength of the fixed beam 180-4 in a dot-and-dash line. Note that when a radiation angle of each of the fixed beams 180-1 to 180-4 radiated from each of the antenna elements 111-1 to 111-4 is properly adjusted according to a distance d between the antenna elements 111 in the array antenna 110, interference on one fixed beam by another fixed beams disappears at a predetermined pointing angle, as illustrated in FIG. 7. Specifically, for example, in a direction at a pointing angle around −50°, interference on the fixed beam 180-1 by the fixed beams 180-2 to 180-4 disappears. Further, for example, in a direction at a pointing angle around −15°, interference on the fixed beam 180-2 by the fixed beams 180-1, 180-3, and 180-4 disappears. Then, for example, in a direction at a pointing angle around 15°, interference on the fixed beam 180-3 by the fixed beams 180-1, 180-2, and 180-4 disappears. For example, in a direction at a pointing angle around 50°, interference on the fixed beam 180-4 by the fixed beams 180-1 to 180-3 disappears.

In this case, for example, when a user terminal exists in a direction providing a high strength of the fixed beam 180-1 (a direction at a pointing angle)−50°, a transmission-reception weight is calculated by the weighting processing in the MIMO communication apparatus 100 in such a way that an amount of a component of the fixed beam 180-1 contained in a composite beam related to a signal aimed at the user terminal is more than amounts of components of the fixed beams 180-2 to 180-4. Specifically, in this example, a strength of a signal output from the communication circuit 130-1 in the signal aimed at the user terminal is stronger than a strength of signals output from the communication circuits 130-2 to 130-4 in the MIMO communication apparatus 100.

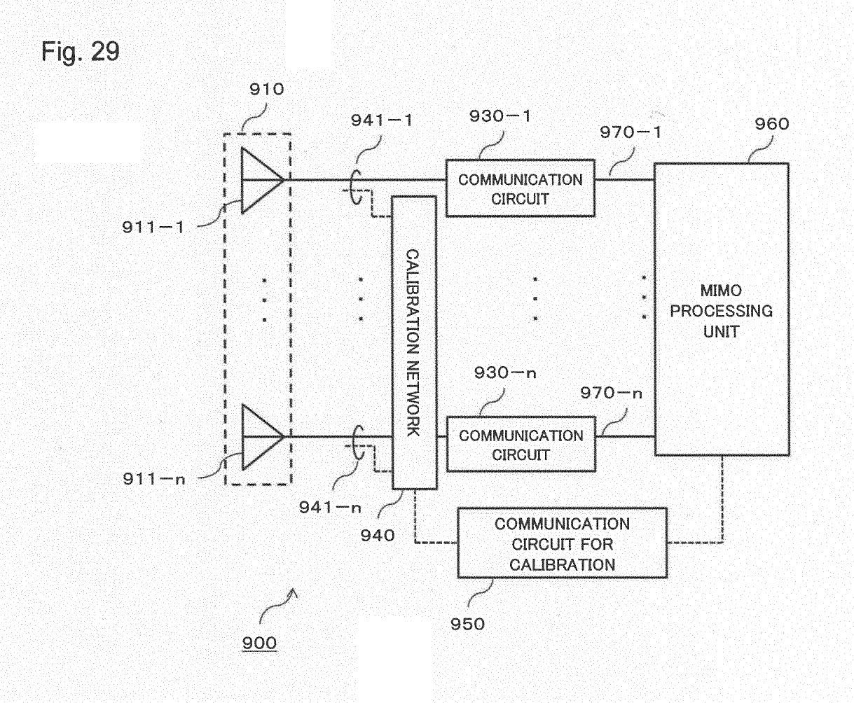

In this case, when an error occurs in the calibration processing performed by the MIMO processing unit 160, a relative error occurs between signals after calibration processing output from the respective communication circuits 130-1 to 130-n. In this case, when the MIMO transmission-reception weighting processing is performed by the MIMO processing unit 160 in the configuration illustrated in FIG. 29, a beam of a signal aimed at a user terminal nearly evenly contains components of electromagnetic waves output from the antenna elements 910-1 to 910-n. In other words, a plurality of signals in which relative errors are caused by an error in the calibration processing, the signals being output from the respective communication circuits 130-1 to 130-n, are superposed on one another nearly at the same ratio, and therefore a large error occurs in the beam. Note that each of the plurality of signals is a signal output toward the user terminal.

On the other hand, the MIMO communication apparatus 100 according to the present example embodiment is configured in such a way that, as a result of the weighting processing, a composite beam related to a signal aimed at a user terminal contains a component of a fixed beam more than components of other fixed beams, the fixed beam matching its direction providing a high signal strength with a direction of the user terminal. In other words, among signals containing errors, the signals being output from the respective communication circuits 130-1 to 130-n and being aimed at the user terminal, a strength of a signal output from a communication circuit related to the aforementioned fixed beam is greater than a strength of a signal output from another communication circuit. Accordingly, a plurality of fixed beams containing relative errors do not need to be superposed on one another at the same ratio, and communication is performed with the user terminal by a nearly single fixed beam; and therefore an effect of the relative errors between signals caused by an error in the calibration processing is reduced. Thus, even when an error occurs in the calibration processing performed by the MIMO processing unit 160, an effect of the error can be minimized.

Furthermore, for example, when the array antenna 110 receives a communication electromagnetic wave from another communication apparatus (unillustrated), a signal based on the communication electromagnetic wave is distributed to each of the communication circuits 130-1 to 130-n by the network circuit unit 123 through the input-output ports 121-1 to 121-n provided in the feeding network 120.

In this case, the operation described above related to transmission and reception of a beam in the array antenna 110 and the feeding network 120 corresponds to the network circuit unit 123 performing fixed antenna weighting processing in an analog and passive manner. Analog here means digital processing not being performed. Further, passive means the network circuit unit 123 not including an active element such as an analog amplifier. Fixed means the network circuit unit 123 performing antenna weighting processing with a constant distribution ratio at signal distribution.

The signal composition and distribution in the feeding network 120 is performed on n signals corresponding to the number of the communication circuits 130. Digital signal processing equivalent to such composition and distribution of n signals is normally performed by the MIMO processing unit 160 and the n communication circuits 130. On the other hand, in the present invention, composition and distribution corresponding to the digital signal processing is performed on an analog signal in the feeding network 120. With such a configuration, an effect of a relative error between communication circuits 130 caused by an error in the calibration processing being an error factor in digital processing can be further reduced by a difference in ratios of respective fixed beams containing errors, the fixed beams being included in a composite beam.

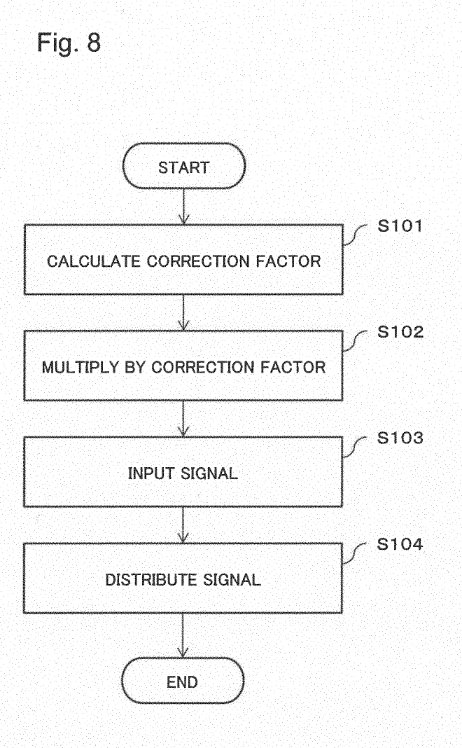

Next, an operation of the MIMO communication apparatus 100 will be described with reference to a drawing. FIG. 8 is a flowchart illustrating processing for the MIMO communication apparatus 100 to transmit a composite beam to a user terminal.

The MIMO processing unit 160 performs the calibration processing and calculates a correction factor (Step S101). Further, the MIMO processing unit 160 multiplies each signal multiplied by a weight matrix by the correction factor, as described above (Step S102). Then, each of the communication circuits 130-1 to 130-n inputs each signal multiplied by the correction factor into the network circuit unit 123 included in the feeding network 120 (Step S103).

In the network circuit unit 123, processing corresponding to antenna weighting processing is performed on each of the signals input from the communication circuits 130-1 to 130-n. Then, the network circuit unit 123 distributes each of the signals performed by the antenna weighting processing to each of the antenna elements 111-1 to 111-n included in the array antenna 110 (Step S104).

Then, each of the antenna elements 111-1 to 111-n radiates a fixed beam based on the distributed signals. The respective fixed beams overlap one another and form a composite beam; and the composite beam is received by a user terminal.

As described above, the MIMO processing unit 160 according to the present example embodiment calculates a weight in such a way that a composite beam related to a signal aimed at a user terminal contains a component of a fixed beam more than components of other fixed beams, the fixed beam matching its direction providing a high signal strength with a direction of the user terminal. Then, the MIMO processing unit 160 multiplies each signal by the weight, the each signal being input to the antenna elements 111-1 to 111-n by each of the communication circuits 130-1 to 130-n. Consequently, a signal aimed at the user terminal is output at a particularly high strength from a communication circuit related to the fixed beam out of the communication circuits 130-1 to 130-n. With such a configuration, when an error occurs in the calibration processing by the MIMO processing unit 160, a composite beam is not formed, the composite beam being formed by overlapping a plurality of fixed beams with errors at the same ratio. Accordingly, even when an error occurs in the calibration processing by the MIMO processing unit 160, an effect of the error can be minimized.

Accordingly, the present example embodiment can prevent degradation in communication performance.

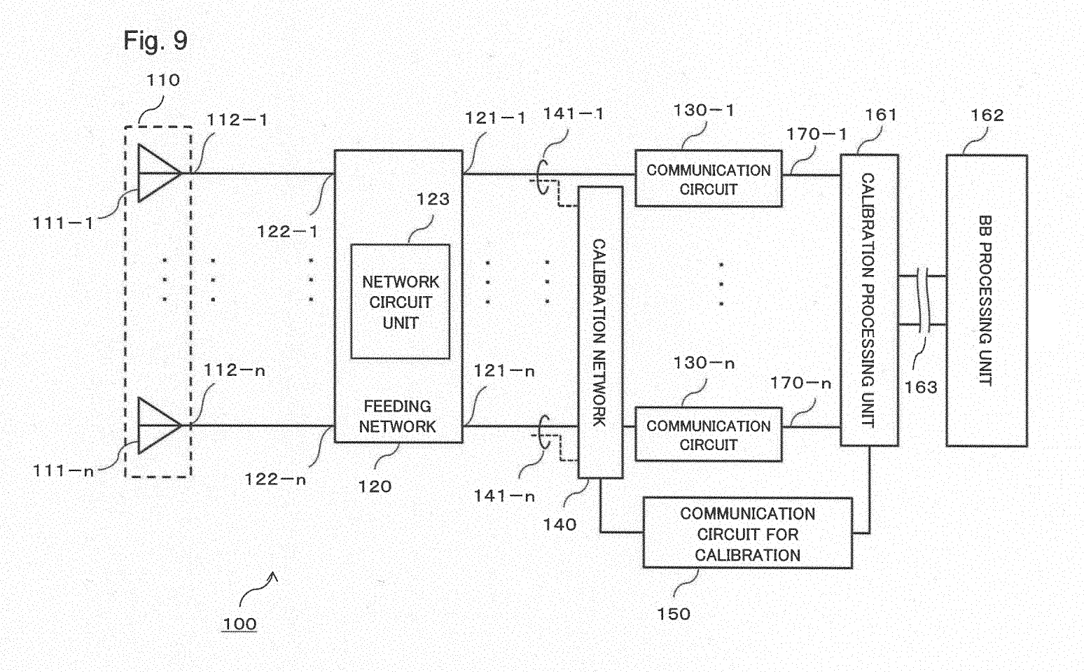

FIG. 9 is a block diagram illustrating a first other configuration example of the MIMO communication apparatus 100. The MIMO communication apparatus 100 according to the present example embodiment may include a calibration processing unit 161 and a baseband (BB) processing unit 162 in place of the MIMO processing unit 160, as is the case with the example illustrated in FIG. 9. Additionally, a configuration in the MIMO communication apparatus 100 excluding the BB processing unit 162 is herein referred to as an antenna apparatus.

The calibration processing unit 161 performs the calibration processing. Specifically, the calibration processing unit 161 calculates a correction factor by which a signal is multiplied.

The BB processing unit 162 performs the processing performed by the MIMO processing unit 160 except for the calibration processing. For example, the BB processing unit 162 performs the MIMO transmission-reception weighting processing and the like.

Note that the calibration processing unit 161 and the BB processing unit 162 may be connected to one another through an interface such as the Common Public Radio Interface (CPRI) 163, and the BB processing unit 162 may be installed outside the MIMO communication apparatus 100. Then, when the MIMO communication apparatus 100 includes a plurality of antenna apparatuses, each calibration processing unit 161 included in each antenna apparatus may be connected to the BB processing unit 162. With such a configuration, various types of processing in the respective antenna apparatuses are performed by the BB processing unit 162, and therefore a coordinated operation between the respective antenna apparatuses can be readily performed.

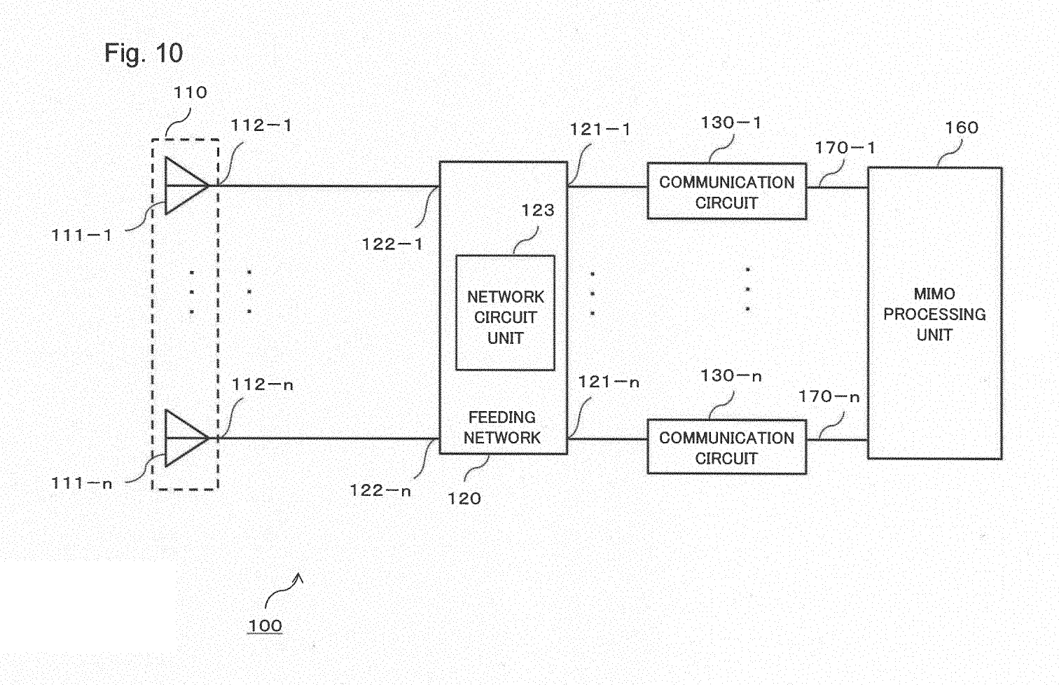

FIG. 10 is a block diagram illustrating a second other configuration example of the MIMO communication apparatus 100. The MIMO communication apparatus 100 according to the present example embodiment may not include the calibration network 140 and the communication circuit for calibration 150, as is the case with the example illustrated in FIG. 10, when an individual performance difference between the respective communication circuits 130 is sufficiently small. In this case, according to the configuration described above that, by the weighting processing, a signal aimed at a user terminal is output at a particularly high strength from a communication circuit related to a fixed beam strongly radiated in a direction of the user terminal out of the communication circuits 130-1 to 130-n, degradation in communication performance of the MIMO communication apparatus 100 caused by an individual performance difference between the communication circuits 130 can be suppressed.

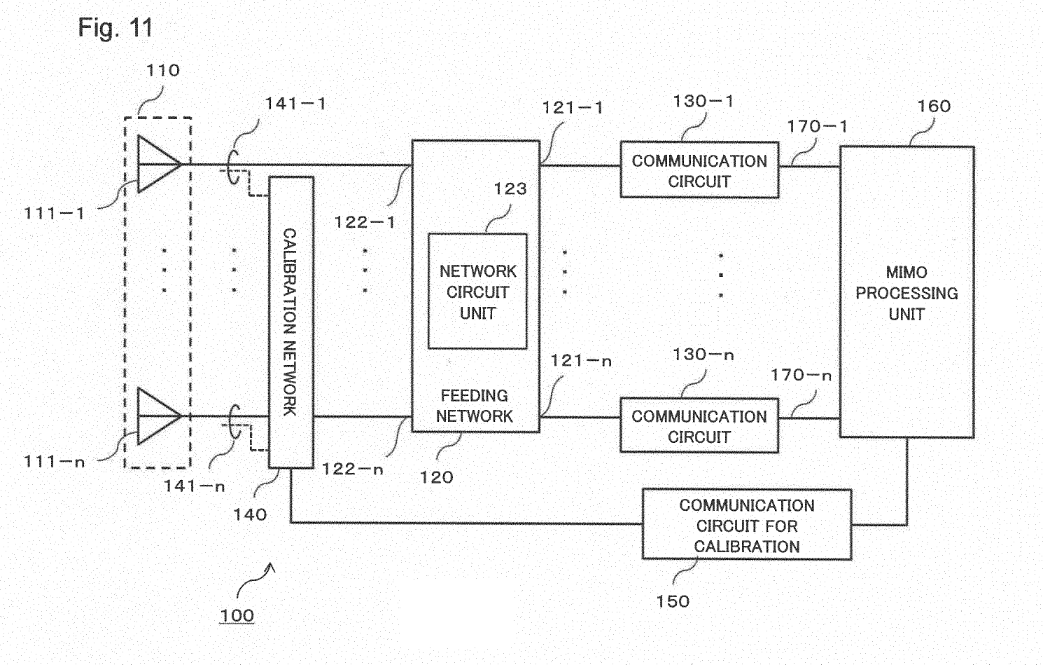

FIG. 11 is a block diagram illustrating a third other configuration example of the MIMO communication apparatus 100. The calibration network 140 according to the present example embodiment may be connected to each of the signal lines between the array antenna 110 and the feeding network 120 through the couplers 141, as illustrated in FIG. 11.

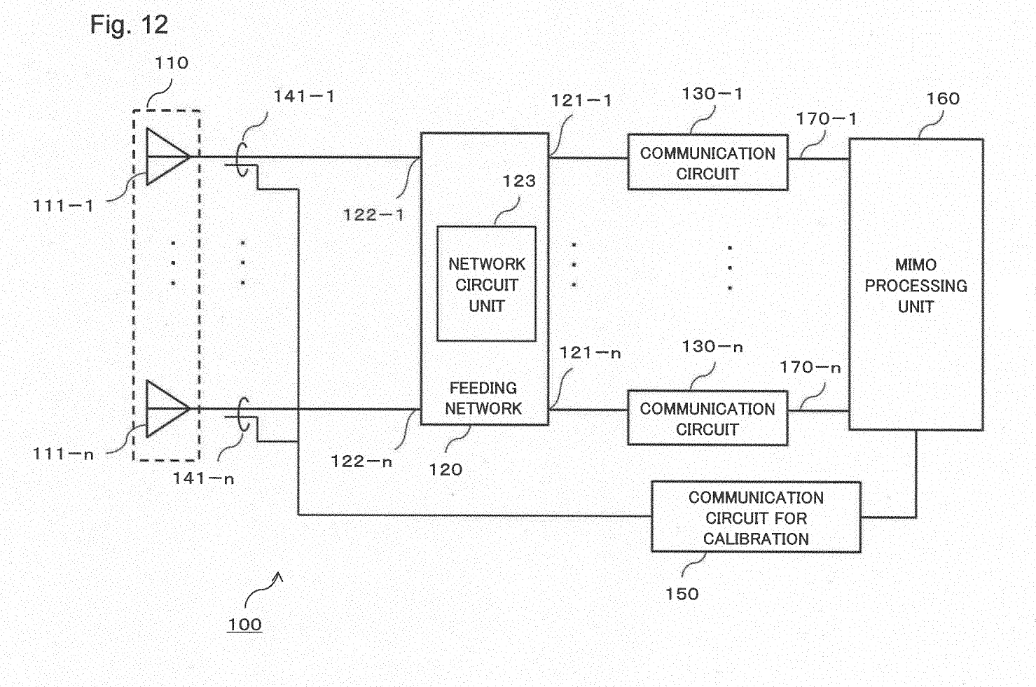

FIG. 12 is a block diagram illustrating a fourth other configuration example of the MIMO communication apparatus 100. The communication circuit for calibration 150 according to the present example embodiment may be connected to each of the signal lines between the array antenna 110 and the feeding network 120 through the couplers 141, as illustrated in FIG. 12.

### Second Example Embodiment

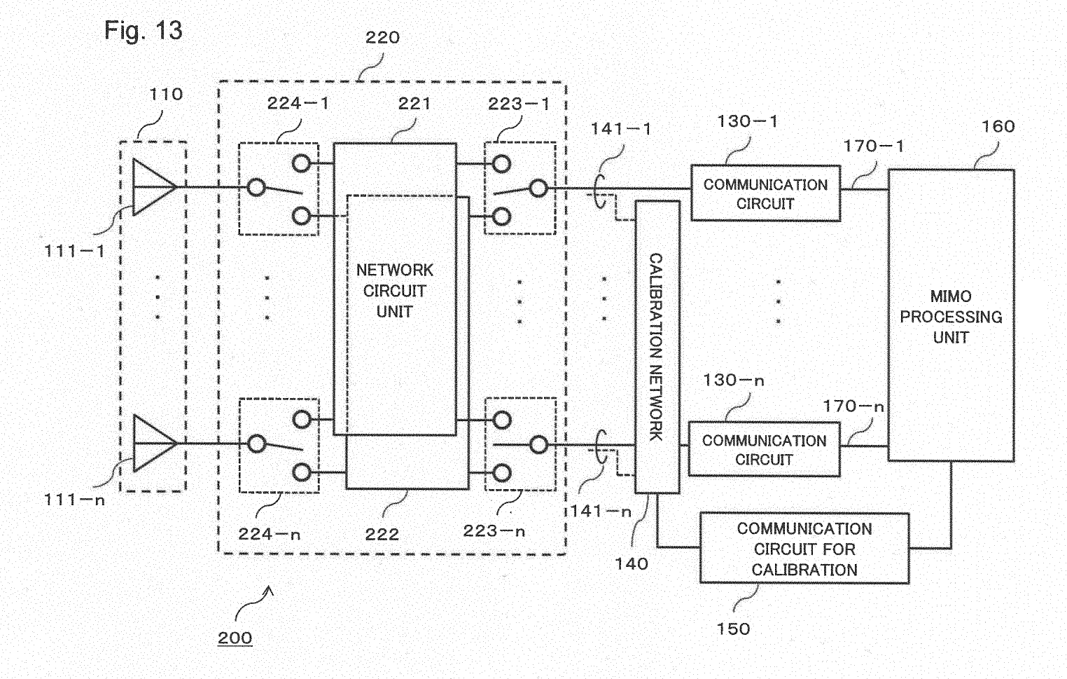

A MIMO communication apparatus 200 according to a second example embodiment will be described with reference to drawings. FIG. 13 is a block diagram illustrating a configuration example of the MIMO communication apparatus 200 according to the present example embodiment.

As illustrated in FIG. 13, the MIMO communication apparatus 200 according to the second example embodiment differs from the MIMO communication apparatus 100 according to the first example embodiment in including a feeding network 220 in place of the feeding network 120. The remaining configuration of the MIMO communication apparatus 200 according to the present example embodiment is similar to the configuration of the MIMO communication apparatus 100 according to the first example embodiment illustrated in FIG. 1; and therefore a corresponding component is given the same sign as that in FIG. 1, and description is omitted.

In the example according to the first example embodiment illustrated in FIG. 6, for example, when there is a user terminal in a direction between the fixed beam 180-1 and the fixed beam 180-2, the MIMO processing unit 160 performs the MIMO transmission-reception weighting processing as follows. Specifically, the MIMO processing unit 160 performs the MIMO transmission-reception weighting processing in such a way that a composite beam of a signal aimed at the user terminal contains the same amount of components of the fixed beams 180-1 and 180-2, and also the composite beam contains more amounts of the components of the fixed beams 180-1 and 180-2 than amounts of components of the fixed beams 180-3 and 180-4. Accordingly, when an error occurs in the calibration processing, a plurality of fixed beams (the fixed beams 180-1 and 180-2 in this example) in which errors occur in the calibration processing are superposed on one another at the same ratio. Thus, the composite beam is affected by the error in the calibration processing.

As illustrated in FIG. 13, the feeding network 220 according to the present example embodiment includes a network circuit unit 221 and a network circuit unit 222. Note that composition and distribution of a signal is performed in the network circuit unit 221 and the network circuit unit 222 in such way that each unit performs antenna weighting processing different from one another. Further, the feeding network 220 includes n switches 223-1 to 223-n on the communication circuits 130-1 to 130-n side. Further, the feeding network 220 includes n switches 224-1 to 224-n on the array antenna 110 side. The switches 223-1 to 223-n are switches capable of alternately switching a connection destination of the communication circuits 130-1 to 130-n between the network circuit unit 221 and the network circuit unit 222. The switches 224-1 to 224-n are capable of alternately switching a connection destination of the antenna elements 111-1 to 111-n between the network circuit unit 221 and the network circuit unit 222. Note that, for example, each of the network circuit unit 221 and the network circuit unit 222 is an electric circuit network providing a Butler matrix, a Blass matrix, or a Rotman lens.

Here, a direction providing a high signal strength of a fixed beam radiated by the array antenna 110 differs between: a case that the network circuit unit 221 distributes signals input from the communication circuits 130-1 to 130-n to each of the antenna elements 111-1 to 111-n; and a case that the network circuit unit 222 distributes the signals input from the communication circuits 130-1 to 130-n to each of the antenna elements 111-1 to 111-n. Specifically, a direction providing a high signal strength of a fixed beam radiated by the array antenna 110 when the network circuit unit 221 distributes the signals is different from a direction providing a high signal strength of a fixed beam radiated by the array antenna 110 when the network circuit unit 222 distributes the signals. The reason is that signals are distributed in such a way that the antenna weighting processing with a different distribution ratio is performed in each of the network circuit unit 221 and the network circuit unit 222.

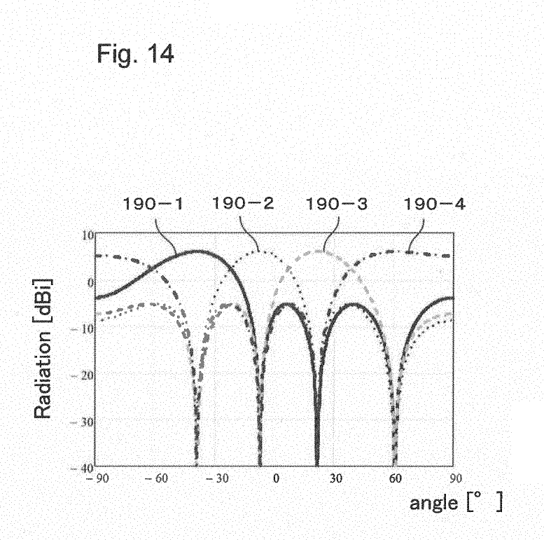

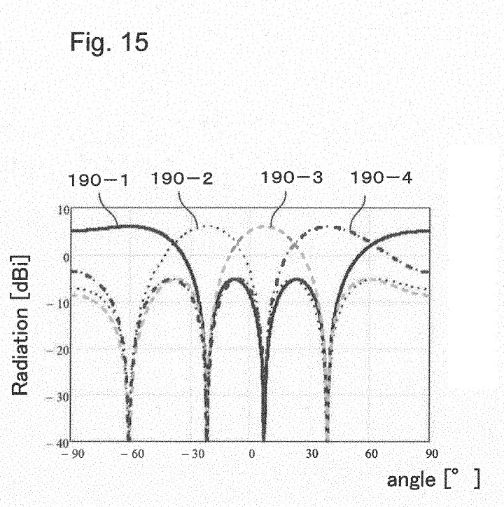

FIG. 14 is a diagram illustrating an example of a signal strength in each direction of four fixed beams 190-1 to 190-4 radiated by the array antenna 110 when the network circuit unit 221 distributes signals input from the communication circuits 130-1 to 130-n to each of the antenna elements 111-1 to 111-n. Further, FIG. 15 is a diagram illustrating an example of a signal strength in each direction of the four fixed beams 190-1 to 190-4 radiated by the array antenna 110 when the network circuit unit 222 distributes the signals input from the communication circuits 130-1 to 130-n to each of the antenna elements 111-1 to 111-n. Note that, in the diagrams in FIGS. 14 and 15, a signal strength of the fixed beam 190-1 is indicated in a solid line, a signal strength of the fixed beam 190-2 is indicated in a dotted line, a signal strength of the fixed beam 190-3 is indicated in a broken line, and a signal strength of the fixed beam 190-4 is indicated in a dot-and-dash line.

In the example illustrated in FIG. 14, a direction between a direction maximizing a signal strength of the fixed beam 190-1 and a direction maximizing a signal strength of the fixed beam 190-4 is a direction around −60°. On the other hand, in the example illustrated in FIG. 15, a direction maximizing a signal strength of the fixed beam 190-1 is the direction around −60°. Accordingly, as can be understood from the examples illustrated in FIGS. 14 and 15, a direction providing a high signal strength of a fixed beam radiated from the array antenna 110 differs between: a case that the network circuit unit 221 distributes signals to the antenna elements 111-1 to 111-n; and a case that the network circuit unit 222 distributes the signals to the antenna elements 111-1 to 111-n.

Taking advantage of such a characteristic, the feeding network 220 controls conducting directions of the switches 223 and 224, and determines which of the network circuit unit 221 and the network circuit unit 222 distributes signals input from the communication circuits 130-1 to 130-n to the antenna elements 111-1 to 111-n, depending on a direction of a user terminal.

In the examples illustrated in FIGS. 14 and 15, when a user terminal exists in a direction at −60°, the feeding network 220 controls conducting directions of the switches 223-1 to 223-n and the switches 224-1 to 224-n in such a way as to cause the network circuit unit 222 to perform distribution of signals input from the communication circuits 130-1 to 130-n to each of the antenna elements 111-1 to 111-n. The reason is as follows.

When the network circuit unit 221 is used in this example, a composite beam contains the same amounts of components of a plurality of fixed beams (a component of the fixed beam 190-1 and a component of the fixed beam 190-2 in this example). Accordingly, when an error occurs in the calibration processing performed by the MIMO processing unit 160, the plurality of fixed beams with errors are superposed on one another at the same ratio, and therefore the composite beam contains a large error. Consequently, communication performance of the MIMO communication apparatus 200 degrades.

By contrast, when the network circuit unit 222 is used in this example, the composite beam contains a component of a fixed beam (the fixed beam 190-1 in this example) more than any other components, the fixed beam matching its direction providing a high signal strength with the direction of the user terminal. Accordingly, even when an error occurs in the calibration processing performed by the MIMO processing unit 160, a plurality of fixed beams with errors are not superposed on one another at the same ratio. Thus, an effect of the error in the calibration processing can be minimized. Consequently, degradation in communication performance of the MIMO communication apparatus 200 can be prevented. Therefore, in this example, the feeding network 220 causes the network circuit unit 222 to distribute signals input from the communication circuits 130-1 to 130-n to each of the antenna elements 111-1 to 111-n.

As described above, the MIMO communication apparatus 200 according to the present example embodiment controls conducting directions of the switches 223-1 to 223-n and the switches 224-1 to 224-n depending on a direction of a user terminal. Then, the MIMO communication apparatus 200 determines whether to distribute signals input from the communication circuits 130-1 to 130-n to the antenna elements 111-1 to 111-n by the network circuit unit 221 or 222. Accordingly, the present example embodiment can prevent degradation in communication performance regardless of a direction of the user terminal, in addition to providing an effect similar to that of the first example embodiment.

### Third Example Embodiment

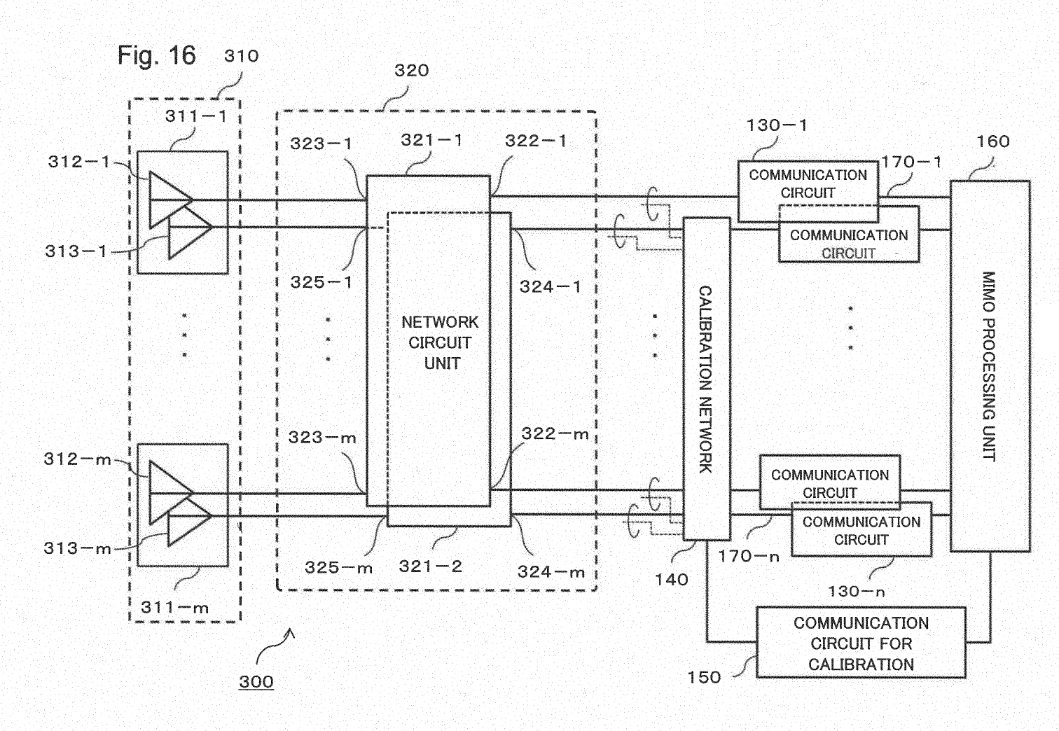

A MIMO communication apparatus 300 according to a third example embodiment will be described with reference to drawings. FIG. 16 is a block diagram illustrating a configuration example of the MIMO communication apparatus 300 according to the third example embodiment.

As illustrated in FIG. 16, the MIMO communication apparatus 300 according to the third example embodiment differs from the MIMO communication apparatus 100 according to the first example embodiment in including an array antenna 310 in place of the array antenna 110 and including a feeding network 320 in place of the feeding network 120. The remaining configuration of the MIMO communication apparatus 300 according to the present example embodiment is similar to the configuration of the MIMO communication apparatus 100 according to the first example embodiment illustrated in FIG. 1; and therefore a corresponding component is given the same sign as that in FIG. 1, and description is omitted.

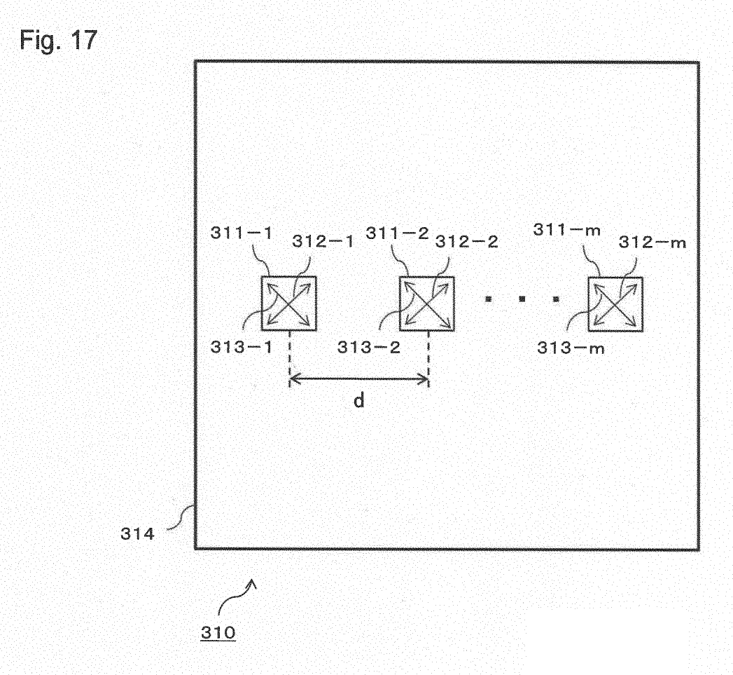

FIG. 17 is a front view illustrating a configuration example of the array antenna 310. As illustrated in FIG. 17, the array antenna 310 includes m dual polarization antennas 311-1 to 311-m and a conductive reflector 314. Then, each of the dual polarization antennas 311-1 to 311-m includes an antenna element 312 and an antenna element 313. Additionally, each of antenna elements 312-1 to 312-m respectively included in the dual polarization antennas 311-1 to 311-m is related to one polarized wave. Further, each of antenna elements 313-1 to 313-m respectively included in the dual polarization antennas 311-1 to 311-m is related to another polarized wave. Then, the dual polarization antennas 311-1 to 311-m are installed on the conductive reflector 314 in such a way that a distance d between dual polarization antennas 311 adjoining one another (for example, between the dual polarization antenna 311-1 and the dual polarization antenna 311-2) is ½ of a wavelength λ of a beam transmitted and received by the array antenna 310. Additionally, m and n satisfy a relational expression n=m×2, according to the present example embodiment.

As illustrated in FIG. 16, the feeding network 320 includes a network circuit unit 321-1 and a network circuit unit 321-2.

In this case, the network circuit unit 321-1 may be provided with m input-output ports 322-1 to 322-m being input-output terminals, on the communication circuits 130-1 to 130-n side. Further, the network circuit unit 321-1 may be provided with m input-output ports 323-1 to 323-m being input-output terminals, on the array antenna 310 side.

Then, the network circuit unit 321-2 may be provided with m input-output ports 324-1 to 324-m being input-output terminals, on the communication circuits 130-1 to 130-n side. The network circuit unit 321-2 may be provided with m input-output ports 325-1 to 325-m being input-output terminals, on the array antenna 310 side. A case that the network circuit unit 321-1 is provided with the input-output ports 322-1 to 322-m and the input-output ports 323-1 to 323-m, and the network circuit unit 321-2 is provided with the input-output ports 324-1 to 324-m and the input-output ports 325-1 to 325-m will be described below as an example.

With such a configuration, each of the input-output ports 322-1 to 322-m is connected to each of m communication circuits 130 through m signal lines. Further, the input-output ports 323-1 to 323-m are connected to each of the antenna elements 312-1 to 312-m included in the dual polarization antennas 311-1 to 311-m through the m signal lines. Then, each of the input-output ports 324-1 to 324-m is connected to each of other m communication circuits 130 through other m signal lines. The input-output ports 325-1 to 325-m are connected to each of the antenna elements 313-1 to 313-m included in the dual polarization antennas 311-1 to 311-m through the other m signal lines 170.

When a signal is input from each of the m communication circuits 130 through the input-output ports 322-1 to 322-m, the network circuit unit 321-1 inputs each of the signals into each of the antenna elements 312-1 to 312-m. Further, when a signal is input from the other m communication circuits 130 through the input-output ports 324-1 to 324-m, the network circuit unit 321-2 inputs each of the signals into each of the antenna elements 313-1 to 313-m.

With such a configuration, m fixed beams related to one polarized wave are radiated from the antenna elements 312-1 to 312-m. Further, m fixed beams related to another polarized wave are radiated from the antenna elements 313-1 to 313-m. In other words, m fixed beams related to a polarized wave and m fixed beams related to another polarized wave are radiated from the array antenna 310. Accordingly, the MIMO communication apparatus 300 can support two polarized waves.

Thus, the present example embodiment can provide an effect that two polarized waves can be supported, in addition to an effect similar to that of the first example embodiment.

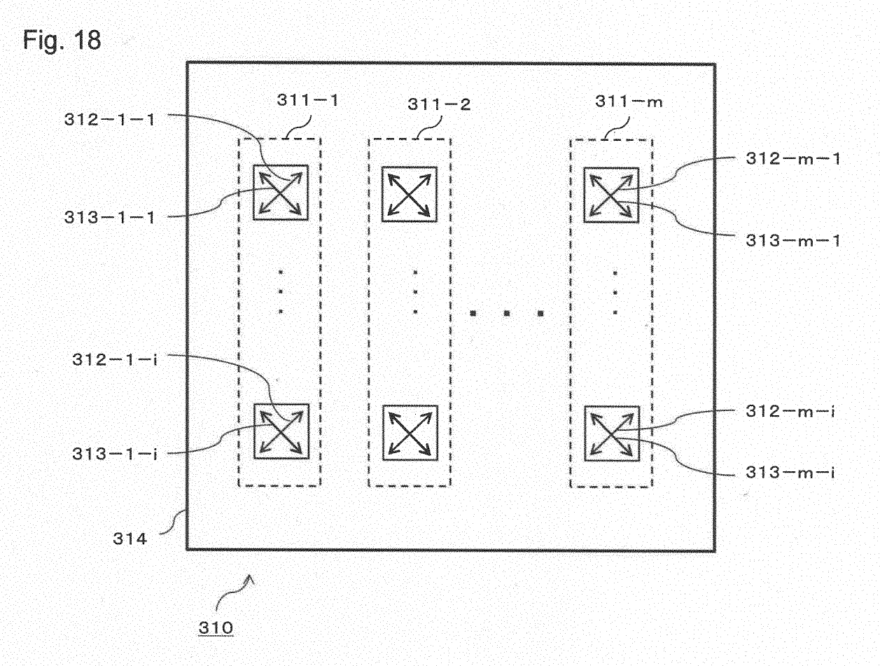

FIG. 18 is a front view illustrating a first other configuration example of the array antenna 310. As illustrated in FIG. 18, each of the dual polarization antennas 311-1 to 311-m may include any number (i) of antenna elements 312 and antenna elements 313, according to the present example embodiment. Note that i is any natural number.

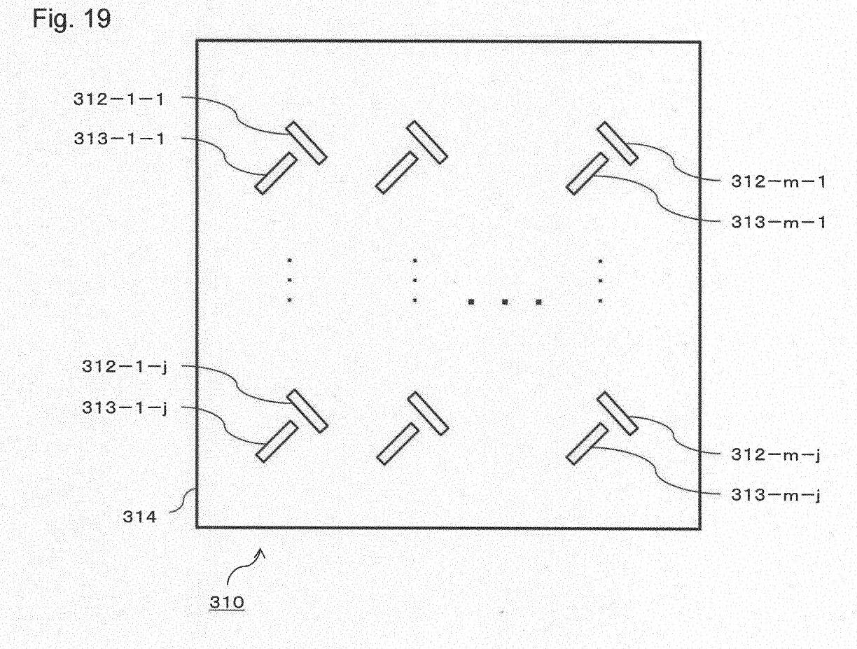

FIG. 19 is a front view illustrating a second other configuration example of the array antenna 310. The antenna elements 312-1 to 312-m and the antenna elements 313-1 to 313-m according to the present example embodiment may be different types from one another. Specifically, for example, each of the antenna elements 312-1 to 312-m may be a patch antenna, and each of the antenna elements 313-1 to 313-m may be a monopole antenna. Further, as illustrated in FIG. 19, the array antenna 310 may not include dual polarization antennas 311-1 to 311-m each including an antenna element 312 and an antenna element 313. Then, as illustrated in FIG. 19, the array antenna 310 may include any number (j) of antenna elements 312-1 to 312-m and antenna elements 313-1 to 313-m. Note that j is any natural number.

Furthermore, while the array antenna 310 includes the same number of antenna elements 312 and antenna elements 313 in the examples illustrated in FIGS. 17 to 19, the numbers of the respective elements do not necessarily need to be the same. In this case, for example, the array antenna 310 includes a antenna elements 312 and n−a antenna elements 313 (where a is any natural number and a≠n−a).

Then, in this case, the network circuit unit 321-1 is provided with a input-output ports on the communication circuits 130-1 to 130-n side. Further, the network circuit unit 321-1 is provided with a input-output ports on the array antenna 310 side. Then, the network circuit unit 321-2 is provided with n−a input-output ports on the communication circuits 130-1 to 130-n side. Further, the network circuit unit 321-2 is provided with n−a input-output ports on the array antenna 310 side.

Furthermore, while one dual polarization antenna 311 is described to include one antenna element 312 and one antenna element 313 in this example, one dual polarization antenna 311 may further include an antenna element related to a polarized wave different from those related to the antenna element 312 and the antenna element 313. With such a configuration, the MIMO communication apparatus 300 can support three polarized waves or more. In other words, the MIMO communication apparatus 300 can support a plurality of polarized waves.

### Fourth Example Embodiment

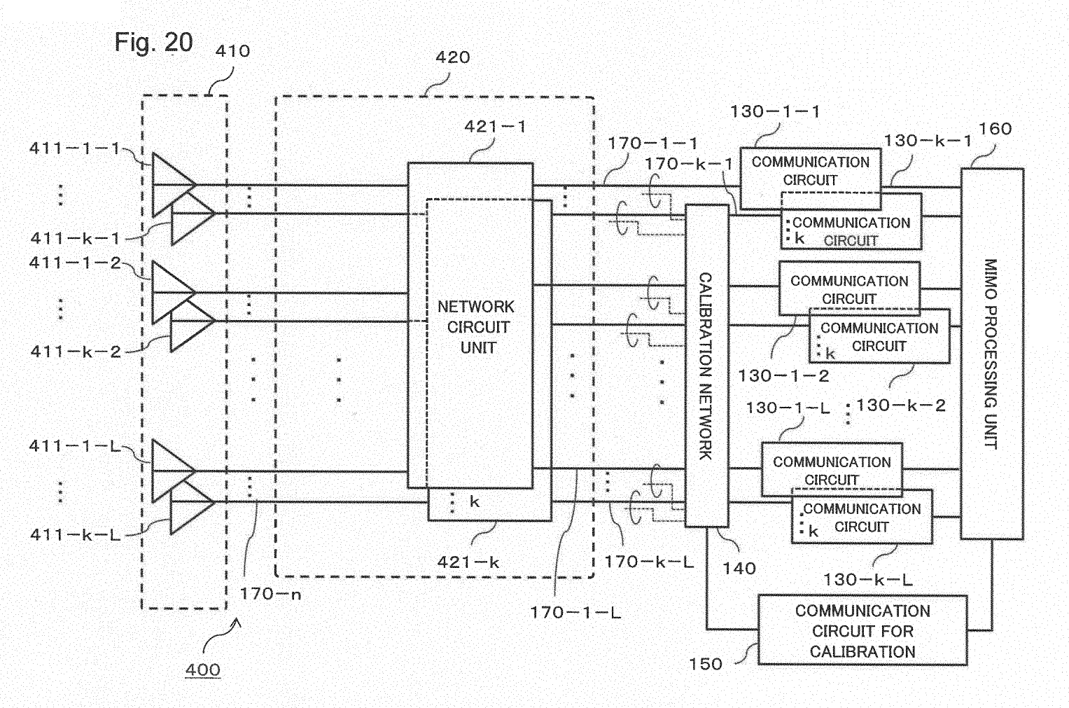

A MIMO communication apparatus 400 according to a fourth example embodiment will be described with reference to drawings. FIG. 20 is a block diagram illustrating a configuration example of the MIMO communication apparatus 400 according to the fourth example embodiment.

The MIMO communication apparatus 400 according to the fourth example embodiment differs from the MIMO communication apparatus 100 according to the first example embodiment in including an array antenna 410 in place of the array antenna 110 and including a feeding network 420 in place of the feeding network 120. The remaining configuration of the MIMO communication apparatus 400 according to the present example embodiment is similar to the configuration of the MIMO communication apparatus 100 according to the first example embodiment illustrated in FIG. 1; and therefore a corresponding component is given the same sign as that in FIG. 1, and description is omitted.

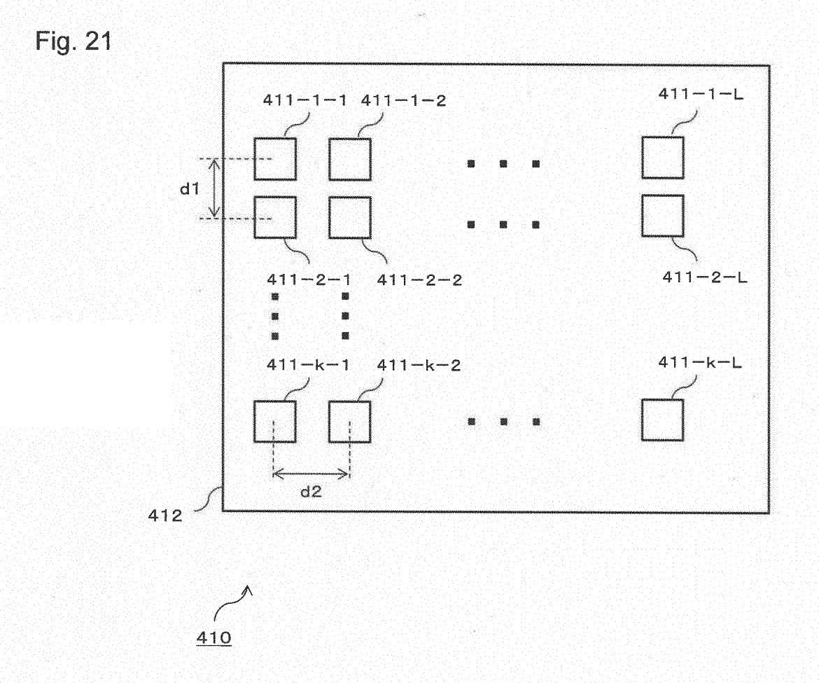

FIG. 21 is a front view illustrating a configuration example of the array antenna 410. As illustrated in FIG. 21, the array antenna 410 includes n (n=L×k) antenna elements 411-1-1 to 411-k-L and a conductive reflector 412. In this case, as illustrated in FIG. 21, the antenna elements 411-1-1 to 411-k-L are arranged side by side at predetermined intervals in longitudinal and lateral directions in a rectangular area. In this example, k antenna elements 411 in the longitudinal direction and L antenna elements 411 in the lateral direction are arranged side by side. Additionally, it is assumed that a length in the lateral direction is longer than a length in the longitudinal direction in the area. Further, each of the antenna elements 411-1-1 to 411-k-L is installed on the conductive reflector 412 in such a way that each of a distance d1 between antenna elements 411 adjoining one another in the longitudinal direction and a distance d2 in the lateral direction is ½ of a wavelength λ of a beam transmitted and received by the array antenna 410. Additionally, variables k, L and n satisfy a relation n=L×k, according to the present example embodiment.

As illustrated in FIG. 20, the feeding network 420 includes k network circuit units 421-1 to 421-k. In this case, each of the network circuit units 421-1 to 421-k may be provided with L input-output ports on the communication circuits 130-1-1 to 130-k-L side as input-output terminals. Further, each of the network circuit units 421-1 to 421-k may be provided with L input-output ports on the array antenna 410 side as input-output terminals. Further, for example, each of the network circuit units 421-1 to 421-k is an electric circuit network providing a Butler matrix, a Blass matrix, or a Rotman lens. A case that L input-output ports are provided on each of the network circuit units 421-1 to 421-k on the communication circuits 130-1-1 to 130-k-L side, and L input-output ports are provided on each of the network circuit units 421-1 to 421-k on the array antenna 410 side will be described below as an example.

With such a configuration, L input-output ports provided on each of the network circuit units 421-1 to 421-k on the communication circuits 130-1-1 to 130-k-L side are connected to the respective communication circuits 130 related to the L input-output ports through signal lines 170-1-1 to 170-k-L.

Specifically, for example, the network circuit unit 421-1 is connected to each of the communication circuit 130-1-1, the communication circuit 130-1-2, . . . , and the communication circuit 130-1-L through L input-output ports. Accordingly, the network circuit unit 421-1 is connected to each communication circuit 130-1-p (where p is any of natural numbers 1 to L). Further, for example, the network circuit unit 421-2 is connected to each of the communication circuit 130-2-1, the communication circuit 130-2-2, . . . , and the communication circuit 130-2-L through L input-output ports. Accordingly, the network circuit unit 421-2 is connected to each communication circuit 130-2-p. Then, for example, the network circuit unit 421-k is connected to each of the communication circuit 130-k-1, the communication circuit 130-k-2, . . . , and the communication circuit 130-k-L through L input-output ports. Accordingly, the network circuit unit 421-k is connected to each communication circuit 130-k-p.

Further, each of the network circuit units 421-1 to 421-k is connected, through L input-output ports, to each of the antenna elements 411 related to the L input-output ports.

Specifically, for example, the network circuit unit 421-1 is connected to each of the antenna element 411-1-1, the antenna element 411-1-2, . . . , and the antenna element 411-1-L through L input-output ports. Accordingly, the network circuit unit 421-1 is connected to each antenna element 411-1-q (where q is any of natural numbers 1 to L). Further, for example, the network circuit unit 421-2 is connected to each of the antenna element 411-2-1, the antenna element 411-2-2, . . . , and the antenna element 411-2-L through L input-output ports. Accordingly, the network circuit unit 421-2 is connected to each antenna element 411-2-q. Then, for example, the network circuit unit 421-k is connected to each of the antenna element 411-k-1, the antenna element 411-k-2, . . . , and the antenna element 411-k-L through L input-output ports. Accordingly, the network circuit unit 421-k is connected to each antenna element 411-k-q.

With such connection, in the example illustrated in FIG. 21, a signal distributed by a network circuit unit 421 is input into each of the L antenna elements 411 arranged side by side in the lateral direction. Specifically, for example, a signal distributed by the network circuit unit 421-1 is input into each of the antenna elements 411-1-1 to 411-1-L. Further, for example, a signal distributed by the network circuit unit 421-2 is input into each of the L antenna elements 411-2-1 to 411-2-L. Then, for example, a signal distributed by the network circuit unit 421-k is input into each of the antenna elements 411-k-1 to 411-k-L.

With such a configuration, the respective L antenna elements 411 arranged side by side in the lateral direction radiate fixed beams with different radiation angles. Note that, radiation angles of the respective fixed beams are different from one another in the lateral direction but radiation angles in the longitudinal direction are the same. In this case, k sets of L antenna elements 411 (referred to as sub-array antennas) arranged side by side in the lateral direction are arranged side by side in the longitudinal direction on the conductive reflector 412. Accordingly, k sets of L fixed beams with different radiation angles in the lateral direction, that is, a total of n (n=L×k) fixed beams are radiated from the array antenna 410. In this case, when the network circuit units 421-1 to 421-k are the same network circuit units, the respective fixed beams in the k sets of fixed beams are the same. On the other hand, when the network circuit units 421-1 to 421-k are different network circuit units, the respective fixed beams in the k sets of fixed beams are different.

With such a configuration, for example, when each of the network circuit units 421-1 to 421-k performs different signal distribution, L or more fixed beams with mutually different radiation angles in the lateral direction are radiated from the array antenna 410, and therefore fixed beams can be radiated at wider angles in the lateral direction, according to the present example embodiment. Further, k sets of L antenna elements 411 arranged side by side in the lateral direction are arranged side by side in the longitudinal direction on the array antenna 410 included in the MIMO communication apparatus 400 according to the present example embodiment. With such a configuration, fixed beams radiated from the array antenna 410 also overlap one another in the longitudinal direction and form a composite beam. Consequently, the MIMO communication apparatus 400 can form a more number of composite beams than the MIMO communication apparatus 100 according to the first example embodiment. Accordingly, communication performance can be further improved.

Furthermore, signal distribution with a different distribution ratio may be performed in each of the network circuit units 421-1 to 421-k according to the present example embodiment, similarly to the network circuit unit 221 and the network circuit unit 222 according to the second example embodiment.

Further, a length in the longitudinal direction and a length in the lateral direction of the rectangular area in which the antenna elements 411-1-1 to 411-k-L are arranged side by side on the conductive reflector 412 may be the same, according to the present example embodiment.

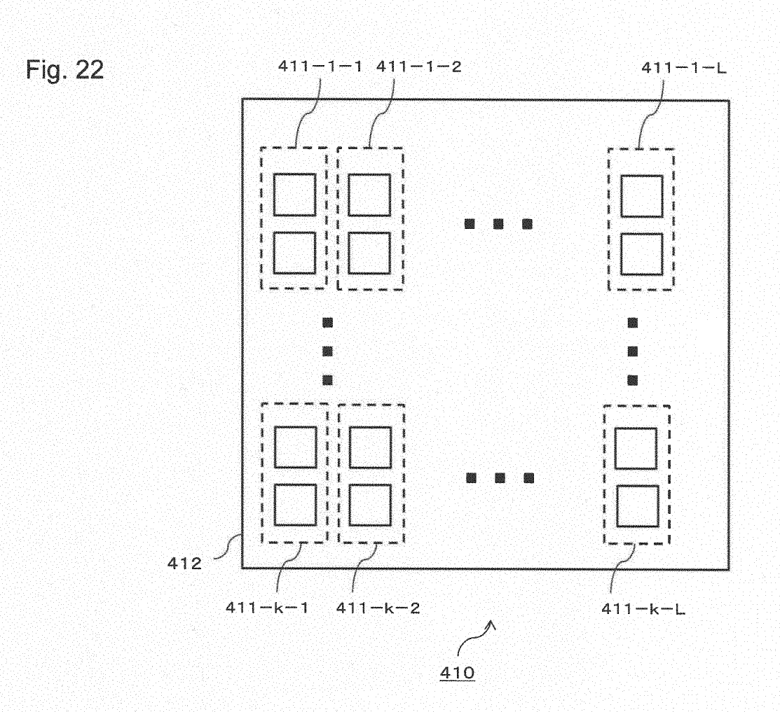

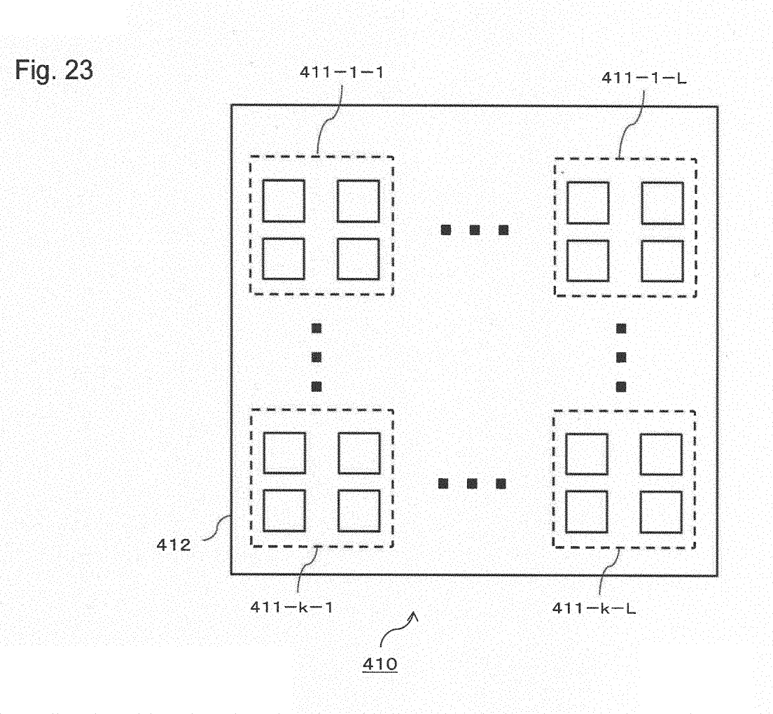

FIG. 22 is a front view illustrating a first other configuration example of the array antenna 410. Further, FIG. 23 is a front view illustrating a second other configuration example of the array antenna 410. As illustrated in FIGS. 22 and 23, each of the antenna elements 411-1-1 to 411-k-L according to the present example embodiment may be configured to include any plurality of sub-antenna elements. In the example illustrated in FIG. 22, each of the antenna elements 411-1-1 to 411-k-L is configured with two antenna elements. Further, in the example illustrated in FIG. 23, each of the antenna elements 411-1-1 to 411-k-L is configured with four antenna elements.

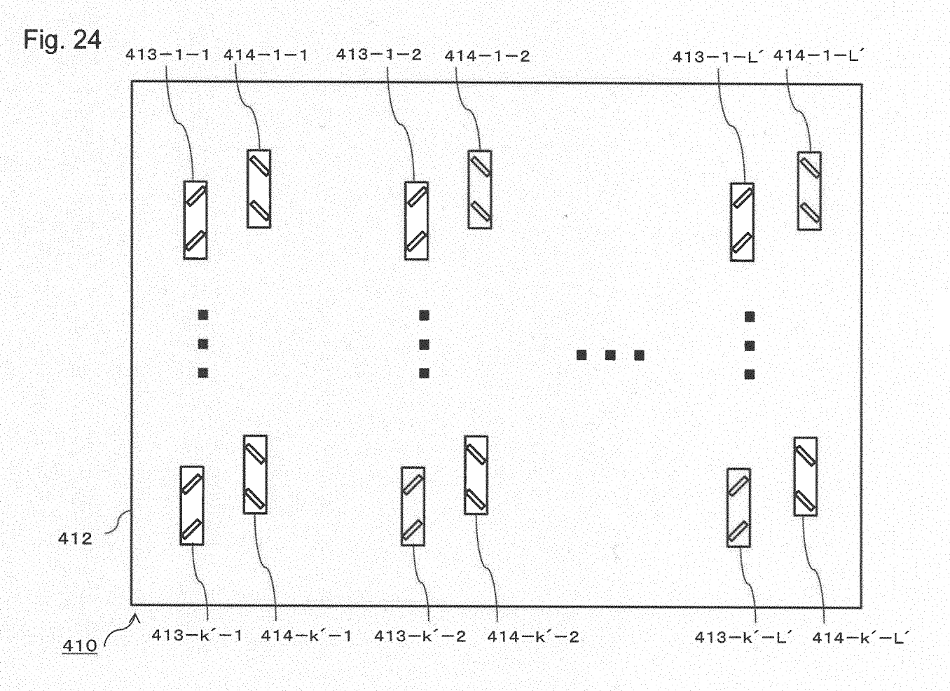

FIG. 24 is a front view illustrating a third other configuration example of the array antenna 410. The array antenna 410 according to the present example embodiment may be configured as the example illustrated in FIG. 24 in order for the MIMO communication apparatus 400 to support two polarized waves. Specifically, the array antenna 410 may include m (m=L′×k′) antenna elements 413 related to one polarized wave and m (m=L′×k′) antenna elements 414 related to the other polarized wave in place of the antenna elements 411-1-1 to 411-k-L. Additionally, the variables m and n satisfy a relational expression n=m×2. With such a configuration, the MIMO communication apparatus 400 can support two polarized waves. Additionally, in such a configuration, the feeding network 420 is provided with L′ input-output ports on each of the communication circuits 130-1-1 to 130-k-L side and the array antenna 410 side, and also includes k′ network circuits related to one polarized wave. Further, the feeding network 420 is provided with L′ input-output ports on each of the communication circuits 130-1-1 to 130-k-L side and the array antenna 410 side, and also includes k′ network circuits related to the other polarized wave.

### Fifth Example Embodiment

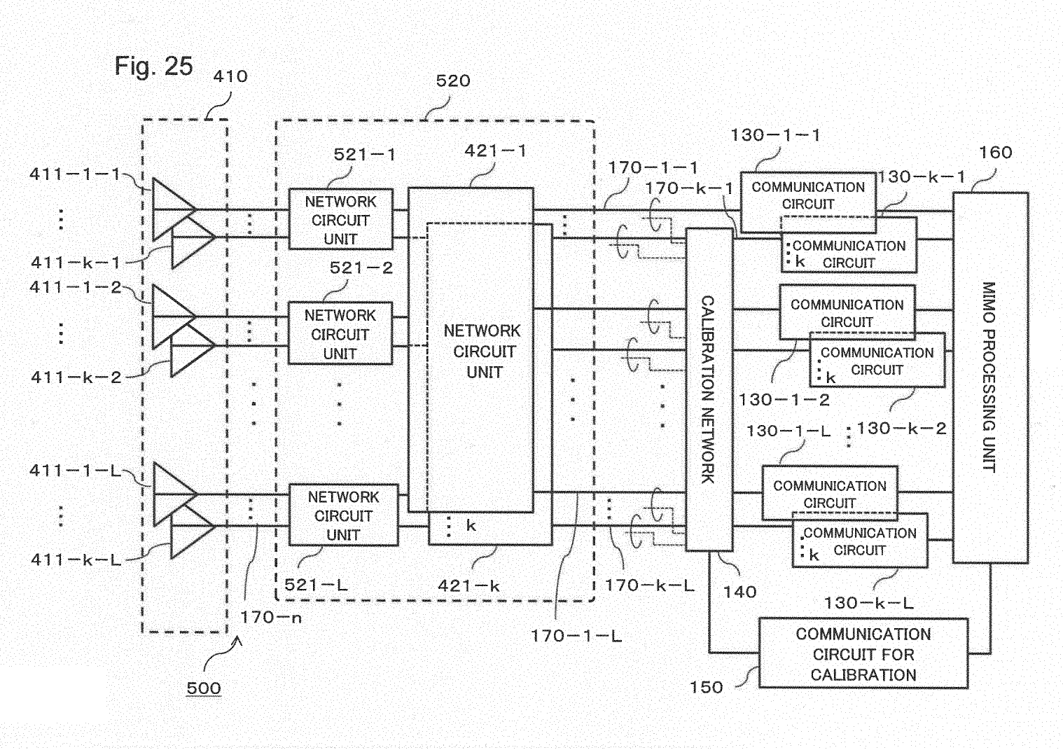

A MIMO communication apparatus 500 according to a fifth example embodiment will be described with reference to drawings. FIG. 25 is a block diagram illustrating a configuration example of the MIMO communication apparatus 500 according to the fifth example embodiment.

The MIMO communication apparatus 500 according to the fifth example embodiment differs from the MIMO communication apparatus 400 according to the fourth example embodiment in including a feeding network 520 in place of the feeding network 420. The remaining configuration of the MIMO communication apparatus 500 according to the present example embodiment is similar to the configuration of the MIMO communication apparatus 400 according to the fourth example embodiment illustrated in FIG. 20; and therefore a corresponding component is given the same sign as that in FIG. 20, and description is omitted.

In addition to the configuration of the feeding network 420 according to the fourth example embodiment, the feeding network 520 further includes L network circuit units 521-1 to 521-L. The network circuit units 521-1 to 521-L are arranged between network circuit units 421-1 to 421-k and an array antenna 410, and are mutually connected to both. Additionally, the variables k, L and n satisfy a relational expression L×k=n, according to the present example embodiment.

Specifically, for example, the network circuit unit 521-1 is connected to each of an antenna element 411-1-1, an antenna element 411-2-1, . . . , and an antenna element 411-k-1. Accordingly, the network circuit unit 521-1 is connected to each antenna element 411-r-1 (where r is any of natural numbers 1 to k). Additionally, the network circuit unit 521-1 is connected to each of the network circuit units 421-1 to 421-k.

Further, for example, the network circuit unit 521-2 is connected to each of an antenna element 411-1-2, an antenna element 411-2-2, . . . , and an antenna element 411-k-2. Accordingly, the network circuit unit 521-2 is connected to each antenna element 411-r-2. Additionally, the network circuit unit 521-2 is connected to each of the network circuit units 421-1 to 421-k.

Then, for example, the network circuit unit 521-L is connected to each of an antenna element 411-1-L, an antenna element 411-2-L, . . . , and an antenna element 411-k-L. Accordingly, the network circuit unit 521-L is connected to each antenna element 411-r-L. Additionally, the network circuit unit 521-L is connected to each of the network circuit units 421-1 to 421-k.

With such a configuration, each signal distributed by the network circuit units 421-1 to 421-k is input into the network circuit units 521-1 to 521-L. Then, the network circuit units 521-1 to 521-L distribute, to 421-k to each of the antenna elements 411-1-1 to 411-k-L, each signal input to the network circuit units 421-1. Specifically, for example, the network circuit unit 521-1 distributes a signal to each of the antenna elements 411-1-1 to 411-k-1. Further, for example, the network circuit unit 521-2 distributes a signal to each of the antenna elements 411-1-2 to 411-k-2. Then, for example, the network circuit unit 521-L distributes a signal to each of the antenna elements 411-1-L to 411-k-L.

In this case, signal distribution by the network circuit units 421-1 to 421-k causes respective radiation angles of fixed beams in a lateral direction radiated by the array antenna 410 to be different. Further, signal distribution by the network circuit units 521-1 to 521-L causes respective radiation angles of the fixed beams in a longitudinal direction radiated by the array antenna 410 to be different. Specifically, for example, each electromagnetic wave radiated by each of the antenna element 411-1-1, the antenna element 411-1-2, . . . , and the antenna element 411-k-L is superposed on one another, and a fixed beam with a different angle in each of the longitudinal direction and the lateral direction is radiated. Then, in the example illustrated in FIG. 21, k sets of L antenna elements 411 arranged side by side in the lateral direction are arranged side by side in the longitudinal direction on the conductive reflector 412. Consequently, n (n=L×k) fixed beams with different angles in each of the longitudinal direction and the lateral direction are radiated from the array antenna 410. In other words, n fixed beams are radiated from the array antenna 410, the n fixed beams having mutually different directions where a signal strength is maximized.

With such a configuration, the MIMO communication apparatus 500 can radiate fixed beams at wider angles in the longitudinal direction and the lateral direction. The MIMO communication apparatus 500 can radiate more fixed beams than the MIMO communication apparatus 100 according to the first example embodiment. Consequently, degradation in communication performance cam be further prevented.

Accordingly, the present example embodiment can further prevent degradation in communication performance.

Note that signal distribution with a different distribution ratio may be performed in each of the network circuit units 421-1 to 421-k and the network circuit units 521-1 to 521-L according to the present example embodiment, similarly to the network circuit unit 221 and the network circuit unit 222 according to the second example embodiment.

### Sixth Example Embodiment

A communication apparatus 600 according to a sixth example embodiment will be described with reference to drawings.

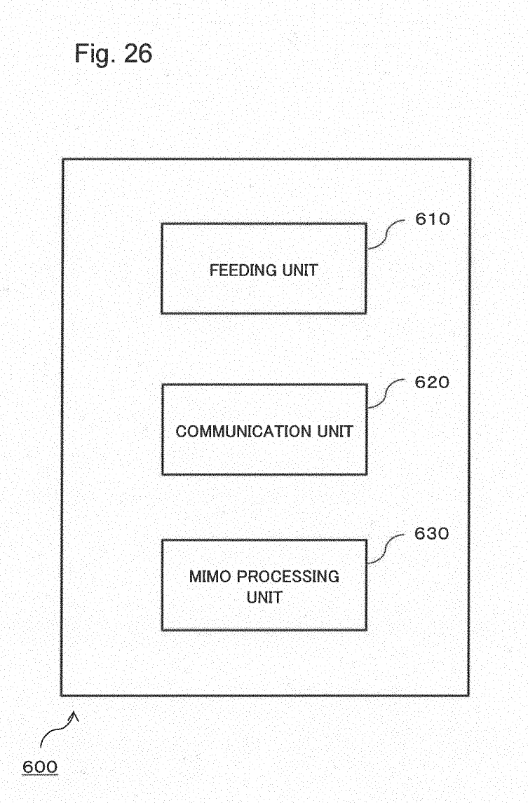

FIG. 26 is a block diagram illustrating a configuration example of the communication apparatus 600 according to the sixth example embodiment. In the example illustrated in FIG. 26, the communication apparatus 600 includes a feeding unit 610, a plurality of communication units 620, and a MIMO processing unit 630.

For example, the feeding unit 610 here is equivalent to the feeding network 120 according to the first example embodiment illustrated in FIG. 1. Further, for example, each of the plurality of communication units 620 is equivalent to each of the communication circuits 130-1 to 130-n according to the first example embodiment illustrated in FIG. 1. Then, for example, the MIMO processing unit 630 is equivalent to the MIMO processing unit 160 according to the first example embodiment illustrated in FIG. 1.

The feeding unit 610 distributes an input analog transmission signal to a plurality of antenna elements (unillustrated). Further, the feeding unit 610 distributes analog reception signals received and input by the plurality of antenna elements to the plurality of communication units 620.

Each of the plurality of communication units 620 converts a digital signal into an analog signal, and vice versa.

The MIMO processing unit 630 inputs a digital signal for transmission to the plurality of communication units 620, based on a MIMO communication technique. Further, the MIMO processing unit 630 performs processing on digital signals based on analog reception signals input by the plurality of communication units 620.

Furthermore, the plurality of communication units 620 input, into the feeding unit 610, analog transmission signals acquired by converting a digital signal for transmission input by the MIMO processing unit 630 into analog signals. Further, the plurality of communication units 620 convert analog reception signals distributed and input by the feeding unit 610 into digital signals based on the analog reception signals. Then, the plurality of communication units 620 input the digital signals into the MIMO processing unit 630.

Furthermore, the feeding unit 610 distributes the same number of analog signals based on analog reception signals as the plurality of communication units 620 to the plurality of communication units 620. Further, the feeding unit 610 distributes the same number of analog signals for transmission as the plurality of communication units 620 to the plurality of antenna elements in such a way that electromagnetic waves having respective predetermined phase differences are radiated.

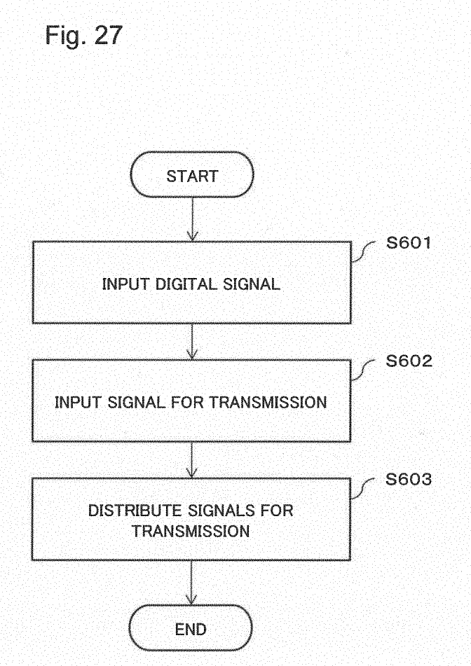

Next, an operation example of the communication apparatus 600 will be described with reference to FIG. 27. FIG. 27 is a flowchart illustrating an operation example of the communication apparatus 600.

The MIMO processing unit 630 inputs a digital signal for transmission to the plurality of communication units 620, based on the MIMO communication technique (Step S601).

The plurality of communication units 620 convert the digital signals for transmission input by the MIMO processing unit 630 into analog transmission signals. Then, each of the plurality of communication units 620 inputs the signal for transmission into the feeding unit 610 (Step S602).

The feeding unit 610 distributes the same number of analog transmission signals as the plurality of communication units 620 to the plurality of antenna elements in such a way that electromagnetic waves having respective predetermined phase differences are radiated (Step S603).

Then, the plurality of antenna elements radiate beams based on the signals for transmission.

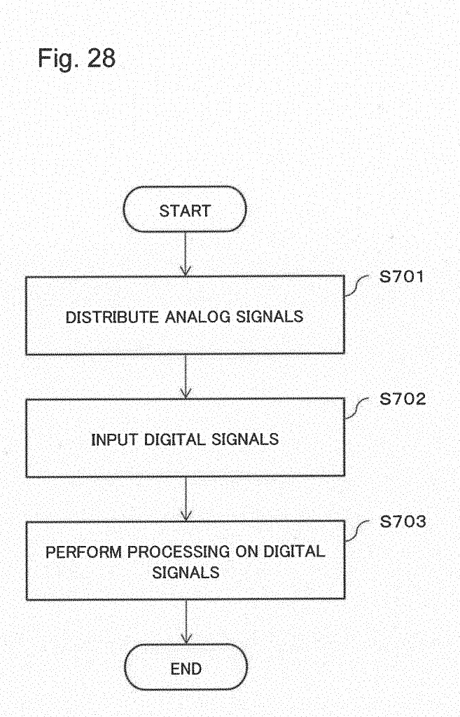

Next, another operation example of the communication apparatus 600 will be described with reference to FIG. 28. FIG. 28 is a flowchart illustrating another operation example of the communication apparatus 600.

The feeding unit 610 distributes analog reception signals received and input by the plurality of antenna elements to the plurality of communication units 620 (Step S701).

The plurality of communication units 620 convert the analog reception signals distributed and input by the feeding unit 610 into digital signals based on the analog reception signals. Then, the plurality of communication units 620 input the digital signals into the MIMO processing unit 630 (Step S702).

The MIMO processing unit 630 performs processing on the digital signals input by the plurality of communication units 620 (Step S703).

According to the present example embodiment, the same number of analog transmission signals as the plurality of communication units 620 are distributed to the plurality of antenna elements in such a way that electromagnetic waves having respective predetermined phase differences are radiated. Then, the plurality of antenna elements radiate beams based on the signals for transmission. Accordingly, for example, even when an error occurs in calibration processing performed by the communication apparatus 600 in order to radiate a beam to a terminal being a communication counterpart, degradation in communication performance of the communication apparatus 600 caused by the error can be minimized.

Accordingly, the present example embodiment can prevent degradation in communication performance.

While the respective example embodiments of the present invention have been described above, the present invention is not limited to the respective aforementioned example embodiments, and further modification, substitution, and/or adjustment can be made within the basic technological concept of the present invention. Further, the respective example embodiments may be implemented in combination as appropriate.

Furthermore, the disclosure of each of the aforementioned PTLs is incorporated herein by reference thereto. The example embodiments may be changed and adjusted within the scope of the entire disclosure (including the claims) of the present invention, and on the basis of the basic technological concept thereof. Further, within the scope of the claims of the present invention, various disclosed elements may be combined and selected in a variety of ways. That is to say, it is apparent that the present invention includes various modifications and changes that may be made by a person skilled in the art, on the basis of the entire disclosure including the claims, and the technological concept.

The whole or part of the example embodiments disclosed above can be described as, but not limited to, the following supplementary notes.

### [Supplementary Note 1]

A communication apparatus comprising:

a plurality of communication means for converting a digital signal into an analog signal, and vice versa;

feeding means for distributing input analog transmission signals to a plurality of antenna elements, and distributing, to the plurality of communication means, analog reception signals received and input by the plurality of antenna elements; and

MIMO processing means for, based on a MIMO communication technique, inputting digital signals for transmission to the plurality of communication means and performing processing on digital signals input by the plurality of communication means, the digital signals being based on the analog reception signals, wherein

the plurality of communication means
input, into the feeding means, the analog transmission signals acquired by converting the digital signals for transmission input by the MIMO processing means into the analog signals, and
convert the analog reception signals distributed and input by the feeding means into the digital signals based on the analog reception signals and input the digital signals into the MIMO processing means, and

the feeding means
distributes the analog signals based on a same number of the analog reception signals as the plurality of communication means, to the plurality of communication means, and
distributes a same number of the analog transmission signals as the plurality of communication means, to the plurality of antenna elements, in such a way that electromagnetic waves having respective predetermined phase differences are radiated.

### [Supplementary Note 2]

The communication apparatus according to Supplementary Note 1, wherein

the feeding means includes an electric circuit network providing a Butler matrix, a Blass matrix, or a Rotman lens.

### [Supplementary Note 3]

The communication apparatus according to Supplementary Note 1 or 2, further comprising the plurality of antenna elements.

### [Supplementary Note 4]

The communication apparatus according to Supplementary Note 3, wherein

the plurality of antenna elements are arranged at a predetermined interval from one another.

### [Supplementary Note 5]

The communication apparatus according to Supplementary Note 3 or 4, wherein

each of the plurality of antenna elements includes a plurality of sub-antenna elements.

### [Supplementary Note 6]

The communication apparatus according to Supplementary Note 5, wherein

the plurality of sub-antenna elements are related to a plurality of types of polarized waves different from one another, and

the communication apparatus further comprises a plurality of types of the feeding means related to the plurality of respective types of polarized waves.

### [Supplementary Note 7]

The communication apparatus according to any one of Supplementary Notes 3 to 6, wherein

each of the plurality of antenna elements is arranged side by side in a lateral direction and a longitudinal direction in a rectangular area, and

each sub-array antenna is configured with a series of the plurality of antenna elements, each series being arranged side by side in a lateral direction or a longitudinal direction.

### [Supplementary Note 8]

The communication apparatus according to any one of Supplementary Notes 1 to 7, further comprising

a plurality of the feeding means, each of which is related to each of the plurality of antenna elements.

### [Supplementary Note 9]

A communication terminal communicating with a communication apparatus, the communication terminal comprising:

a plurality of communication means for converting a digital signal into an analog signal, and vice versa;

feeding means for distributing input analog transmission signals to a plurality of antenna elements, and distributing, to the plurality of communication means, analog reception signals received and input by the plurality of antenna elements; and

MIMO processing means for, based on a MIMO communication technique, inputting digital signals for transmission to the plurality of communication means and performing processing on digital signals input by the plurality of communication means, the digital signals being based on the analog reception signals, wherein

the plurality of communication means
input, into the feeding means, the analog transmission signals acquired by converting the digital signals for transmission input by the MIMO processing means into the analog signals, and
convert the analog reception signals distributed and input by the feeding means into the digital signals based on the analog reception signals, and input the digital signals into MIMO processing means, and

the feeding means
distributes the analog signals based on a same number of the analog reception signals as the plurality of communication means, to the plurality of communication means, and
distributes a same number of the analog transmission signals as the plurality of communication means, to the plurality of antenna elements, in such a way that electromagnetic waves having respective predetermined phase differences are radiated.

### [Supplementary Note 10]

A communication method comprising:

a communication step of converting a digital signal into an analog signal, and vice versa;

a feeding step of distributing input analog transmission signals to a plurality of antenna elements, and distributing, to the plurality of communication means, analog reception signals received and input by the plurality of antenna elements;

a MIMO processing step of, based on a MIMO communication technique, inputting digital signals for transmission to the plurality of communication means and performing processing on digital signals input by the plurality of communication means, the digital signals being based on the analog reception signals;

the communication step further comprising:

inputting, into the feeding means executing the feeding step, the analog transmission signals acquired by converting the digital signals for transmission input to the plurality of communication means in the MIMO processing step into the analog signals; and

converting the analog signals based on the analog reception signals distributed and input by the feeding means into the digital signals based on the analog reception signals, and inputting the digital signals into the MIMO processing means executing the MIMO processing step;

the feeding step further comprising:

distributing the analog signals based on a same number of the analog reception signals as the plurality of communication means, to the plurality of communication means; and

distributing a same number of the analog transmission signals as the plurality of communication means, to the plurality of antenna elements, in such a way that electromagnetic waves having respective predetermined phase differences are radiated.

### [Supplementary Note 11]

A communication program causing a computer to execute:

a plurality of communication processes of converting a digital signal into an analog signal, and vice versa; and

a MIMO process of, based on a MIMO communication technique, inputting digital signals for transmission to a plurality of communication means for executing the plurality of communication processes and performing processing on digital signals input by the plurality of communication means, the digital signals being based on analog reception signals, wherein,

by the plurality of communication processes,
input analog transmission signals are distributed to a plurality of antenna elements, and the analog transmission signals acquired by converting the digital signals for transmission input to the communication means by the MIMO process into the analog signals are input into feeding means for distributing, to the plurality of communication means, the analog reception signals received and input by the plurality of antenna elements, and
the analog signals based on the analog reception signal distributed and input by the feeding means are converted into the digital signals based on the analog reception signals, and the digital signals are input into the MIMO processing means for executing the MIMO process, and

the feeding means
distributes the analog signals based on a same number of the analog reception signals as the plurality of communication means, to the plurality of communication means, and
distributes a same number of the analog transmission signals as the plurality of communication means, to the plurality of antenna elements, in such a way that electromagnetic waves having respective predetermined phase differences are radiated.

This application is based upon and claims the benefit of priority from Japanese patent application No. 2016-191299, filed on Sep. 29, 2016, the disclosure of which is incorporated herein in its entirety by reference.

### REFERENCE SIGNS LIST

100 MIMO communication apparatus
110 Array antenna
111-1 to 111-n Antenna element
112-1 to 112-n Antenna port
113 Conductive reflector
114-1 to 114-n Sub-antenna element
115-1 to 115-n′ Antenna element
116 Sub-feeding network
117-1 to 117-n Antenna port
120 Feeding network
121-1 to 121-n Input-output port
122-1 to 122-n Input-output port
123 Network circuit unit
130-1 to 130-n Communication circuit
140 Calibration network
141-1 to 141-n Coupler
150 Communication circuit for calibration
160 MIMO processing unit
161 Calibration processing unit
162 BB processing unit
170-1 to 170-n Signal line
180-1 to 180-4 Fixed beam
190-1 to 190-4 Fixed beam
200 MIMO communication apparatus
220 Feeding network
221 Network circuit unit
222 Network circuit unit
223-1 to 223-n Switch
224-1 to 224-n Switch
225-1 to 225-n Input-output port
226-1 to 226-n Input-output port
227-1 to 227-n Input-output port
228-1 to 228-n Input-output port
300 MIMO communication apparatus
310 Array antenna
311-1 to 311-m Dual polarization antenna
312-1 to 312-m Antenna element
313-1 to 313-m Antenna element
314 Conductive reflector
320 Feeding network
321-1, 321-2 Network circuit unit
322-1 to 322-m Input-output port
323-1 to 323-m Input-output port
324-1 to 324-m Input-output port
325-1 to 325-m Input-output port
400 MIMO communication apparatus
410 Array antenna
411-1 to 411-n Antenna element
412 Conductive reflector
413 Antenna element
414 Antenna element
420 Feeding network
421-1 to 421-k Network circuit unit
500 MIMO communication apparatus
520 Feeding network
521-1 to 521-L Network circuit unit
600 Communication apparatus
610 Feeding unit
620 Communication unit
630 MIMO processing unit
900 MIMO communication apparatus
910 Array antenna
911-1 to 911-n Antenna element
930-1 to 930-n Communication circuit
940 Calibration network
941-1 to 941-n Coupler
950 Communication circuit for calibration
960 MIMO processing unit
971-1 to 971-n Signal line

What is claimed is:

1. A communication apparatus comprising:
a plurality of communication units configured to convert a digital signal into an analog signal, and vice versa;
a feeding unit configured to distribute input analog transmission signals to a plurality of antenna elements, and to distribute, to the plurality of communication units, analog reception signals received and input by the plurality of antenna elements; and
a MIMO processing unit configured to, based on a MIMO communication technique, input digital signals for transmission to the plurality of communication units and to perform processing on digital signals input by the plurality of communication units, the digital signals being based on the analog reception signals, wherein
the plurality of communication units
input, into the feeding unit, the analog transmission signals acquired by converting the digital signals for transmission input by the MIMO processing unit into the analog signals, and
convert the analog reception signals distributed and input by the feeding unit into the digital signals based on the analog reception signals and input the digital signals into the MIMO processing unit, and
the feeding unit
distributes the analog signals based on a same number of the analog reception signals as the plurality of communication units, to the plurality of communication units, and
distributes a same number of the analog transmission signals as the plurality of communication units, to the plurality of antenna elements, in such a way that electromagnetic waves having respective predetermined phase differences are radiated.

2. The communication apparatus according to claim 1, wherein
the feeding unit includes an electric circuit network providing a Butler matrix, a Blass matrix, or a Rotman lens.

3. The communication apparatus according to claim 1, further comprising the plurality of antenna elements.

4. The communication apparatus according to claim 3, wherein
the plurality of antenna elements are arranged at a predetermined interval from one another.

5. The communication apparatus according to claim 3, wherein
each of the plurality of antenna elements includes a plurality of sub-antenna elements.

6. The communication apparatus according to claim 5, wherein
the plurality of sub-antenna elements are related to a plurality of types of polarized waves different from one another, and
the communication apparatus further comprises a plurality of types of the feeding units related to the plurality of respective types of polarized waves.

7. The communication apparatus according to claim 3, wherein
each of the plurality of antenna elements is arranged side by side in a lateral direction and a longitudinal direction in a rectangular area, and
each sub-array antenna is configured with a series of the plurality of antenna elements, each series being arranged side by side in a lateral direction or a longitudinal direction.

8. The communication apparatus according to claim 1, further comprising
a plurality of the feeding units, each of which is related to each of the plurality of antenna elements.

9. A communication terminal communicating with a communication apparatus, the communication terminal comprising:
a plurality of communication units configured to convert a digital signal into an analog signal, and vice versa;
a feeding unit configured to distribute input analog transmission signals to a plurality of antenna elements, and to distribute, to the plurality of communication units, analog reception signals received and input by the plurality of antenna elements; and
a MIMO processing unit configured to, based on a MIMO communication technique, input digital signals for transmission to the plurality of communication units and to perform processing on digital signals input by the plurality of communication units, the digital signals being based on the analog reception signals, wherein
the plurality of communication units
input, into the feeding unit, the analog transmission signals acquired by converting the digital signals for transmission input by the MIMO processing unit into the analog signals, and
convert the analog reception signals distributed and input by the feeding unit into the digital signals based on the analog reception signals, and input the digital signals into the MIMO processing unit, and
the feeding unit
distributes the analog signals based on a same number of the analog reception signals as the plurality of communication units, to the plurality of communication units, and
distributes a same number of the analog transmission signals as the plurality of communication units, to the plurality of antenna elements, in such a way that electromagnetic waves having respective predetermined phase differences are radiated.

10. A communication method comprising:
by a plurality of communication units, converting a digital signal into an analog signal, and vice versa;
by a feeding unit, distributing input analog transmission signals to a plurality of antenna elements, and to the plurality of communication units, analog reception signals received and input by the plurality of antenna elements;
based on a MIMO communication technique, inputting digital signals for transmission to the plurality of communication units and performing processing on digital signals input by the plurality of communication units, the digital signals being based on the analog reception signals;
by the plurality of communication units, inputting, into the feeding unit, the analog transmission signals acquired by converting the digital signals for transmission input to the plurality of communication units by a MIMO processing unit into the analog signals;
by the plurality of communication units, converting the analog signals based on the analog reception signals distributed and input by the feeding unit into the digital signals based on the analog reception signals, and inputting the digital signals into the MIMO processing unit;
by the feeding unit, distributing the analog signals based on a same number of the analog reception signals as the plurality of communication units, to the plurality of communication units; and
by the feeding unit, distributing a same number of the analog transmission signals as the plurality of communication units, to the plurality of antenna elements, in such a way that electromagnetic waves having respective predetermined phase differences are radiated.

11. (canceled)
